(19) United States
(12) Patent Application Publication
(10) Pub. No.: US 2022/0039592 A1
(43) Pub. Date: Feb. 10, 2022

(54) INFORMATION PROCESSING APPARATUS, INFORMATION PROCESSING METHOD, AND PROGRAM

(71) Applicant: SONY GROUP CORPORATION, Tokyo (JP)

(72) Inventor: Satoshi OZAKI, Kanagawa (JP)

(73) Assignee: SONY GROUP CORPORATION, Tokyo (JP)

(21) Appl. No.: 17/280,548

(22) PCT Filed: Sep. 26, 2019
(86) PCT No.: PCT/JP2019/037797

§ 371 Date: Mar. 26, 2021

(30) Foreign Application Priority Data
Oct. 4, 2018 (JP) 2018-189372

(51) Int. Cl. A47J 36/32; A47J 44/00

(52) U.S. Cl. CPC A47J 36/321; A47J 44/00

(57) ABSTRACT

There is provided an information processing apparatus including circuitry configured to initiate display of information associated with a plurality of cooking processes for cooking a food item and robot information indicating one cooking process of the plurality of cooking processes to be performed by a robot.

### CROSS REFERENCE TO RELATED APPLICATIONS

This application claims the benefit of Japanese Priority Patent Application JP 2018-189372 filed Oct. 4, 2018, the entire contents of which are incorporated herein by reference.

### TECHNICAL FIELD

The present disclosure relates to an information processing apparatus, an information processing method, and a program.

### BACKGROUND ART

PTL 1 discloses a kitchen task support system that automatically performs task support sufficiently corresponding to a cooking appliance function in accordance with a kitchen task situation of each user.

### CITATION LIST

### Patent Literature

PTL 1: Japanese Patent Application Laid-open No. 2005-284408

### SUMMARY

### Technical Problem

However, in the above-described related art, for example, in a case where a cooking person and a robot perform cooking in parallel, it is difficult for the cooking person to grasp a cooking process or progress by the robot. Therefore, it may be necessary for the cooking person to grasp the entire progress state and instruct the robot to perform a missing process.

In this regard, the present disclosure proposes an information processing apparatus, an information processing method, and a program which are capable of supporting a cooking person and a robot to perform cooking cooperatively and efficiently.

### Solution to Problem

According to an aspect of the present disclosure, there is provided an information processing apparatus including circuitry configured to initiate display of information associated with a plurality of cooking processes for cooking a food item and robot information indicating one cooking process of the plurality of cooking processes to be performed by a robot.

According to another aspect of the present disclosure, there is provided an information processing method including displaying information associated with a plurality of cooking processes for cooking a food item and robot information indicating one cooking process of the plurality of cooking processes to be performed by a robot.

According to another aspect of the present disclosure, there is provided a non-transitory computer-readable medium having embodied thereon a program, which when executed by a computer causes the computer to execute an information processing method, the method including displaying information associated with a plurality of cooking processes for cooking a food item and robot information indicating one cooking process of the plurality of cooking processes to be performed by a robot.

### BRIEF DESCRIPTION OF DRAWINGS

FIG. 1 is a diagram illustrating an example of a cooking support system to which an information processing apparatus according to an embodiment of the present disclosure is applied.

FIG. 2 is a diagram illustrating a configuration example of an information processing apparatus according to an embodiment of the present disclosure.

FIG. 3 is a diagram illustrating an example of a screen of an information processing apparatus according to an embodiment of the present disclosure.

FIG. 4 is a diagram illustrating an example of a screen of an information processing apparatus according to an embodiment of the present disclosure.

FIG. 5 is a diagram illustrating an example of a screen of an information processing apparatus according to an embodiment of the present disclosure.

FIG. 6 is a diagram illustrating an example of a screen of an information processing apparatus according to an embodiment of the present disclosure.

FIG. 7 is a diagram illustrating an example of a screen of an information processing apparatus according to an embodiment of the present disclosure.

FIG. 8 is a diagram illustrating an example of a screen of an information processing apparatus according to an embodiment of the present disclosure.

FIG. 9 is a diagram illustrating an example of a screen of an information processing apparatus according to an embodiment of the present disclosure.

FIG. 10 is a diagram illustrating an example of a screen of an information processing apparatus according to an embodiment of the present disclosure.

FIG. 11 is a diagram illustrating an example of a screen of an information processing apparatus according to an embodiment of the present disclosure.

FIG. 12 is a diagram illustrating an example of a screen of an information processing apparatus according to an embodiment of the present disclosure.

FIG. 13 is a diagram illustrating an example of a screen of an information processing apparatus according to an embodiment of the present disclosure.

FIG. 14 is a diagram illustrating an example of a screen of an information processing apparatus according to an embodiment of the present disclosure.

FIG. 15 is a diagram illustrating an example of an estimation method of an information processing apparatus according to an embodiment of the present disclosure.

FIG. 16 is a diagram illustrating an example of an estimation method of an information processing apparatus according to an embodiment of the present disclosure.

FIG. 17 is a diagram illustrating an example of an estimation method of an information processing apparatus according to an embodiment of the present disclosure.

FIG. 18 is a diagram illustrating an example of an estimation method of an information processing apparatus according to an embodiment of the present disclosure.

FIG. 19 is a diagram illustrating an example of an estimation method of an information processing apparatus according to an embodiment of the present disclosure.

FIG. 20 is a diagram illustrating an example of an estimation method of an information processing apparatus according to an embodiment of the present disclosure.

FIG. 21 is a diagram illustrating an example of a profile of an information processing apparatus according to an embodiment of the present disclosure.

FIG. 22 is a flowchart illustrating an example of a processing procedure performed by an information processing apparatus according to an embodiment of the present disclosure.

FIG. 23 is a flowchart illustrating an example of a processing procedure performed by an information processing apparatus according to an embodiment of the present disclosure.

FIG. 24 is a flowchart illustrating an example of a processing procedure performed by an information processing apparatus according to an embodiment of the present disclosure.

FIG. 25 is a flowchart illustrating an example of a processing procedure performed by an information processing apparatus according to an embodiment of the present disclosure.

FIG. 26 is a flowchart illustrating an example of a processing procedure performed by an information processing apparatus according to an embodiment of the present disclosure.

FIG. 27 is a flowchart illustrating an example of a processing procedure performed by an information processing apparatus according to an embodiment of the present disclosure.

FIG. 28 is a flowchart illustrating an example of a processing procedure performed by an information processing apparatus according to an embodiment of the present disclosure.

FIG. 29 is a diagram illustrating an example of a screen of an information processing apparatus according to a modified example of an embodiment of the present disclosure.

FIG. 30 is a diagram illustrating an example of a screen of an information processing apparatus according to a modified example of an embodiment of the present disclosure.

FIG. 31 is a diagram illustrating an example of a screen G displaying a touch input user interface of an embodiment of the present disclosure.

FIG. 32 is a diagram illustrating a configuration example of a cooking robot according to an embodiment of the present disclosure.

FIG. 33 is a hardware configuration diagram illustrating an example of a computer that realizes functions of an information processing apparatus.

### DESCRIPTION OF EMBODIMENTS

Hereinafter, embodiments of the present disclosure will be described in detail with reference to the appended drawings. Note that, in each of the following embodiments, the same parts will be denoted by the same reference numerals, and redundant description will be omitted. Note that, in embodiments of the present disclosure, food is assumed to be obtained by cooking ingredients by a plurality of cooking processes. Cooking is assumed to include cooking ingredients, arranging them, and the like in a cooking process. Progress of food means an overall progress state of a plurality of cooking processes. Progress of cooking or a cooking process means progress state in a cooking process.

### Embodiments

### <Overview of Information Processing Apparatus According to Embodiments of the Present Disclosure>

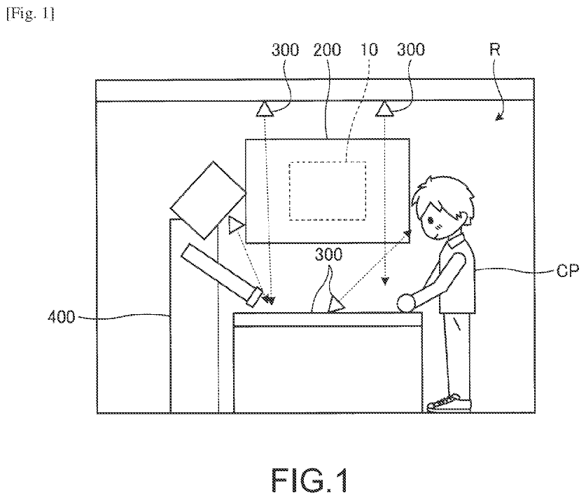

FIG. 1 is a diagram illustrating an example of a cooking support system 1 to which the information processing apparatus according to an embodiment of the present disclosure is applied. As illustrated in FIG. 1, the cooking support system 1 includes an information processing apparatus 10, a touch panel 200, a sensing apparatus 300, and a cooking robot 400. The information processing apparatus 10 is, for example, a dedicated or general-purpose computer. In the information processing apparatus 10, for example, the touch panel 200 and the sensing apparatus 300 are configured to be able to perform transmission and reception of data and signals.

The information processing apparatus 10 causes the touch panel 200 to display a screen that supports a cooking person CP in a case where one or more cooking persons CP and the cooking robot 400 perform cooking in parallel. The cooking person CP is a person who cooks food. Examples of the cooking person CP include a cook who does cooking professionally, a person who does cooking non-professionally, and a kid who helps cooking. The cooking robot 400 is, for example, a two-arm robot imitating a human figure, and is a robot that performs cooking at home, in a restaurant, or the like. Examples of the cooking robot 400 include an autonomous robot that automatically performs cooking and a robot that performs cooking in accordance with an instruction from a human.

The touch panel 200 is an example of a display section. The touch panel 200 performs display, for example, in a cooking room R such as a cooking area of a restaurant or a home kitchen so that the cooking person can view it. Examples of the touch panel 200 include a dedicated touch panel and a touch panel of a smartphone or a tablet. The sensing apparatus 300, for example, collects information related to the cooking person CP in the cooking room, the cooking robot 400, a cooking appliance, a cooking device, a washing place, and the like, and outputs the collected information to the information processing apparatus 10. The sensing apparatus 300 includes, for example, an electronic apparatus such as a camera, a depth sensor, or the like installed on a ceiling of the cooking room R. The sensing apparatus 300 includes, for example, an electronic apparatus such as a camera, a temperature, a weight sensor, or the like installed on a cooking countertop of the cooking room R. The information processing apparatus 10 has a function of collecting sensing information from the sensing apparatus 300 and estimating recognition and motion of the cooking person CP, the progress of the cooking, or the like on the basis of the sensing information. The sensing apparatus 300 collects a voice of the cooking person CP and outputs collected voice data to the information processing apparatus 10.

### <Configuration of Information Processing Apparatus According to Embodiments>

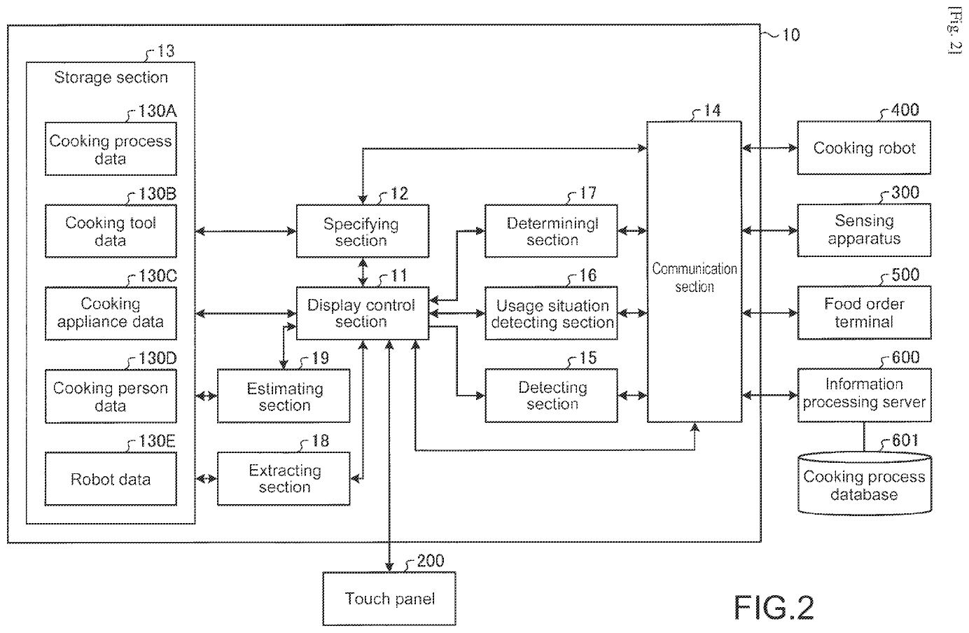

FIG. 2 is a diagram illustrating a configuration example of the information processing apparatus 10 according to an embodiment of the present disclosure. As illustrated in FIG. 2, the information processing apparatus 10 includes a display control section 11, a specifying section 12, a storage section 13, a communication section 14, a detecting section 15, a usage situation detecting section 16, and a determining section 17, an extracting section 18, and an estimating section 19. In an embodiment of the present disclosure, each of the processing sections such as the display control section 11, the specifying section 12, the detecting section 15, the usage situation detecting section 16, the determining section 17, the extracting section 18, and the estimating section 19 is realized, for example, as a central processing section (CPU), a micro control section (MCU), or the like executes a program stored in the information processing apparatus 10 using a random access memory (RAM) or the like as a work area. Further, each processing section may be realized by an integrated circuit such as an application specific integrated circuit (ASIC) or a field-programmable gate array (FPGA).

The display control section 11 causes the touch panel 200 to display support information including process information indicating each of a plurality of cooking processes of cooking food. The support information is information to support cooking of the cooking person CP. For example, the support information is displayed on a screen of the touch panel 200. The screen is a display area of the touch panel 200 that displays the support information or the like. The display control section 11 is able to communicate with the touch panel 200 in a wireless or wired manner and requests the touch panel 200 to display or change the support information. Further, the process information includes, for example, task information indicating task contents in the cooking process and material information indicating a material and a quantity used in the task. The display control section 11 has, for example, a function of causing the touch panel 200 to display information indicating the cooking person CP, the cooking robot 400, or the like to perform the cooking process, in association with the process information. The display control section 11 has a function of changing a display form of the process information, for example, in accordance with the progress of food. Examples of the display form of the process information include a display form indicating a schedule of cooking in which the cooking process is not executed, a display form indicating a state in which the cooking process can be executed, a display form indicating that the cooking process is being executed, and a state indicating an end state of the cooking process. The display control section 11 has a function of causing the touch panel 200 to display information indicating a usage situation of a cooking tool, a cooking appliance, or the like.

The specifying section 12 specifies the cooking process of a plurality of cooking processes, which is to be performed by the cooking robot 400. For example, in a case where the information processing apparatus 10 instructs the cooking robot 400 to perform cooking, the specifying section 12 specifies the cooking process on the basis of contents of the instruction. For example, the specifying section 12 acquires various types of information such as the cooking process, the progress, and the like through communication with the cooking robot 400, and specifies the cooking process on the basis of the acquired information. The specifying section 12 outputs the specified result to the display control section 11.

The storage section 13 stores various types of data. For example, the storage section 13 can store various types of information used in the display control section 11, the specifying section 12, and the like. The storage section 13 stores, for example, cooking process data 130A, cooking tool data 130B, cooking appliance data 130C, cooking person data 130D, robot data 130E, and the like.

The cooking process data 130A is data indicating the cooking process of food. The cooking process data 130A includes, for example, a plurality of pieces of process information corresponding to a plurality of cooking processes of food to be supported. The cooking process data 130A is, for example, data acquired from a cooking process database 601 of an information processing server 600. For example, in a case where food is an egg soup, the cooking process data 130A includes the process information of each of a process of slicing an onion, a process of adding sliced onions to a consomme soup and heating it, a process of mixing an egg, and a process of adding a liquid mixture of starch and water and an egg to the consomme soup and heating it. For example, in the case of a restaurant, the cooking process data 130A is data indicating the cooking process of food corresponding to a menu of the restaurant. The cooking process data 130A includes information indicating a food name. The process information includes the task information indicating a task in the cooking process and the material information indicating a material used in the task.

The cooking tool data 130B is data indicating a cooking tool of the cooking room R used for cooking. Examples of the cooking tool include a frying pan, a pot, a bowl, a scale, a ginseng, a goby, a grater, and a peeler. The cooking tool data 130E includes, for example, tool information corresponding to the cooking tool of the cooking room R. The tool information includes, for example, information indicating a type of cooking tool and a usage situation. The usage situation includes situation such as, for example, unused, in use, washing, and the like.

The cooking appliance data 130C is data indicating the cooking appliance of the cooking room R in which cooking is performed. The cooking appliance includes, for example, a stove, an oven, a cutting board, a washing place, and the like. The cooking appliance data 130C includes, for example, appliance information corresponding to the cooking appliance of the cooking room R. The appliance information includes, for example, information indicating the type of cooking appliance and a usage situation. The usage situation includes, for example, situations such as in use and available.

The cooking person data 130D is data indicating a cooking person who is a cooking support target. The cooking person data 130D includes, for example, information indicating a profile of a cooking person. The profile includes information indicating a feature, a face, and the like to identify a cooking person. The cooking person data 130D includes, for example, information indicating cooking at which a cooking person is good or bad. The cooking person data 130D includes, for example, information indicating whether or not a cooking person is an adult or a kid. The cooking person data 130D includes, for example, information indicating a process in which a cooking person is cooking.

The robot data 130E is data indicating the cooking robot 400 that cooks in the cooking room R. The robot data 130E includes, for example, information indicating a profile of the cooking robot 400. The profile includes information indicating a feature, a model, specifications, and the like to identify the cooking robot 400. The robot data 130E includes, for example, information indicating cooking at which the cooking robot 400 is good. The robot data 130E includes, for example, information indicating a process in which the cooking robot 400 is cooking.

Examples of the storage section 13 include a RAM, a semiconductor memory device such as a flash memory, a hard disk, and an optical disk. Note that the storage section 13 may he installed in an electronic apparatus different from the information processing apparatus 10. Specifically, the storage section 13 may be installed in a cloud server connected to the information processing apparatus 10 via a network.

The communication section 14 has a function of performing information communication with electronic apparatuses such as, for example, the sensing apparatus 300, the cooking robot 400, a food order terminal 500, and the information processing server 600 via a network. Specifically, the communication section 14 outputs the information or the like received from the electronic apparatus to the respective processing sections of the information processing apparatus 10. The communication section 14 transmits information or the like from the respective processing sections of the information processing apparatus 10 to an electronic apparatus of a transmission destination.

The food order terminal 500 includes, for example, a handy terminal, a smartphone, and a tablet terminal. The food order terminal 500, for example, provides information indicating input food to the information processing apparatus 10. The information processing server 600 is a so-called cloud server and has a function of managing the cooking process database 601. The information processing server 600 extracts the cooking process data 130A of the food instructed from the information processing apparatus 10 from the cooking process database 601 and provides it to the information processing apparatus 10.

The detecting section 15 detects the progress of the food. The detecting section 15 analyzes, for example, motions of the cooking person CP and the cooking robot 400, the cooking contents, the cooking tool being used, the cooking appliance, and the like on the basis of the sensing information of the sensing apparatus 300. The detecting section 15 detects the progress of the food on the basis of an analysis result. The detecting section 15 detects the progress of the food, for example, by comparing an elapsed time since the food is started with a scheduled elapsed time of the cooking process. The detecting section 15 outputs the detected result to the display control section 11. Then, the display control section 11 causes the touch panel 200 to change the display form of the process information on the basis of the detection result of the detecting section 15.

The detecting section 15 detects a cooking process in which the cooking person performs cooking. The detecting section 15 analyzes, for example, the motion of the cooking person CP, the cooking contents, the cooking tool being used, the cooking appliance, or the like, on the basis of the sensing information of sensing apparatus 300. Then, the detecting section 15 detects the cooking process performed by the cooking person on the basis of the analysis result and a learning result of cooking in the cooking process. The detecting section 15 outputs the detected cooking result of the cooking person to the display control section 11. Then, the display control section 11 causes the touch panel 200 to display the cooking person information indicating the cooking person in association with the process information indicating the cooking process detected by the detecting section 15.

The detecting section 15 detects the occurrence of an abnormality in the cooking process. The detecting section 15 analyzes, for example, the presence or absence of the occurrence of an abnormality related to the cooking process on the basis of the sensing information of the sensing apparatus 300. Examples of the abnormality related to the cooking process include incompletion of the cooking process is not completed even in a case where an estimated time is passed, detection of abnormal heating or smoke, and a mistake in the task in the cooking process. The detecting section 15 outputs information indicating the detected abnormality to the display control section 11. Then, the display control section 11 causes the process information of the cooking process detected by the detecting section 15 to he abnormally displayed.

The usage situation detecting section 16 detects the usage situation of the cooking tool indicated by the tool information of the cooking tool data 130B. The usage situation detecting section 16 recognizes the cooking tool on the basis of the sensing information or the like of the sensing apparatus 300 and detects the usage situation of the cooking tool. For example, the usage situation detecting section 16 outputs information indicating the detected usage situation of each cooking tool to the display control section 11. Then, the display control section 11 changes the tool information to indicate the usage situation of the cooking tool detected by the usage situation detecting section 16.

The usage situation detecting section 16 detects the usage situation of the cooking appliance indicated by the appliance information of the cooking tool data 130B. The usage situation detecting section 16 recognizes the cooking appliance on the basis of the sensing information or the like of the sensing apparatus 300 and detects the usage situation of the cooking appliance. The usage situation detecting section 16 outputs information indicating the detected usage situation of each cooking appliance to the display control section 11. Further, the usage situation detecting section 16 may detect, for example, the usage situation on the basis of information acquired through communication with the cooking appliance via communication section 14. Then, the display control section 11 changes the appliance information to indicate the usage situation of the cooking appliance detected by the usage situation detecting section 16.

The determining section 17 determines whether or not the cooking person views the touch panel 200, The determining section 17 specifies the direction of the face of the cooking person CP in the cooking room R on the basis of the sensing information of the sensing apparatus 300. If the direction of the face is directed to the touch panel 200, the determining section 17 determines that the cooking person is viewing the touch panel 200. Further, if the direction of the face is not directed to the touch panel 200, the determining section 17 determines that the cooking person is not viewing the touch panel 200. The determining section 17 outputs the determination result to the display control section 11. Then, the display control section 11 changes the display contents of the touch panel 200 on the basis of the cooking person determined to be viewing by the determining section 17. Note that the determining section 17 may determine that the cooking person is viewing the touch panel 200 in a case where the direction of the line of sight, the head, or the like of the cooking person CP is directed to the touch panel 200.

The extracting section 18 extracts the process information (the cooking process) of a plurality of pieces of process information being displayed, which can be unified, in a case where the touch panel 200 includes the process information for every two or more foods. The extracting section 18 compares, for example, task contents of the cooking process indicated by a plurality of pieces of process information, and extracts it as the cooking process which can be unified in a case where the task contents are identical or similar. The extracting section 18 outputs an extraction result indicating the extracted the process information which can be unified to the display control section 11. Then, if the display control section 11 extracts the process information which can be unified by the extracting section 18, the display control section 11 causes the touch panel 200 to display unification information indicating the cooking process to be communized in association with the process information.

For example, a first cooking process is assumed to include task contents of mixing two eggs, and a second cooking process includes a task of mixing four eggs. In this case, the extracting section 18 extracts first process information and second process information indicating the cooking process which can be unified, and outputs an extraction result indicating the unified process information to the display control section 11. In an embodiment of the present disclosure, the extracting section 18 adds a material of the cooking process indicated by the unified process information, generates unification information indicating the task of mixing six eggs, and outputs the unification information to the display control section 11 as the extraction result. Then, the display control section 11 causes the touch panel 200 to display the unification information in association with a plurality of pieces of process information to be unified. Note that the extracting section 18 may output an extraction result indicating the extracted process information to the display control section 11, and the display control section 11 may generate the unification information on the basis of the extraction result.

The estimating section 19 estimates the cooking process of the plurality of food cooking processes, at which the cooking robot 400 is not good. The estimating section 19 estimates the weak cooking process of the cooking robot 400, for example, on the basis of contents of cooking, the robot data 130E, or the like. The estimating section 19 estimates one of the cooking person CF and the cooking robot 400 which can efficiently perform the cooking process on the basis of an estimation method. Note that an example of the estimation method will be described later. The estimating section 19 outputs the estimation result to the display control section 11, Then, the display control section 11 causes the touch panel 200 to display second information indicating that the cooking robot is not good in association with the process information indicating the cooking process estimated by the estimating section 19. Note that the estimating section 19 may estimate, for example, the cooking process of a plurality of food cooking processes, at which the cooking robot 400 is good, or estimate at least one cooking process at which the cooking person CP is good or bad.

The functional configuration example of the information processing apparatus 10 according to an embodiment of the present disclosure has been described above. Note that the above configuration described with reference to FIG. 2 is merely an example, and the functional configuration of the information processing apparatus 10 according to embodiments of the present disclosure is not limited to the example. The functional configuration of the information processing apparatus 10 according to embodiments of the present disclosure can be flexibly modified in accordance with the specifications or operations.

### <Display Example of Information Processing Apparatus According to Embodiments>

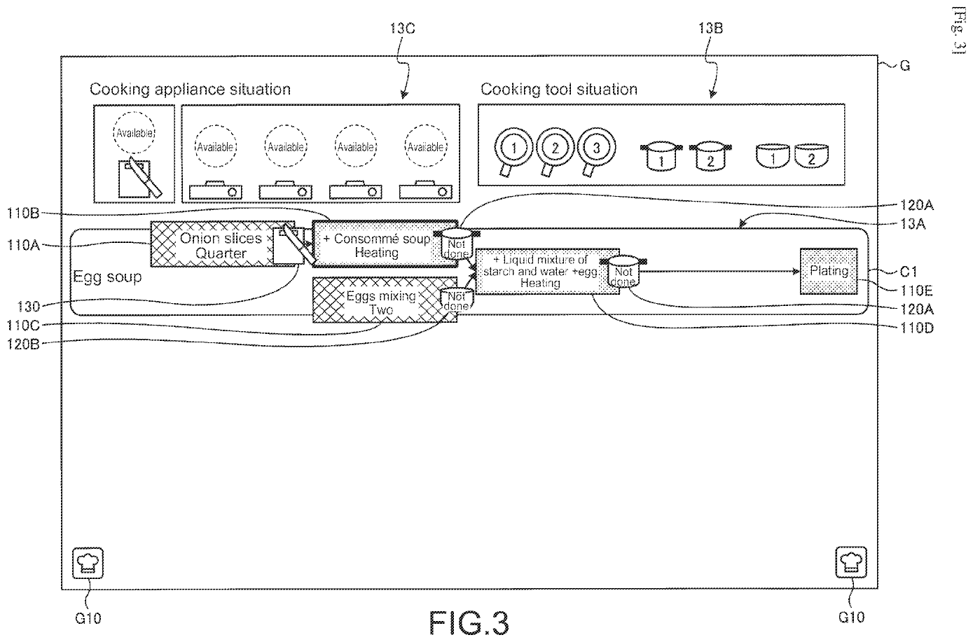

Next, an example of display of the information processing apparatus 10 according to an embodiment of the present disclosure will he described with reference to FIGS. 3 to 14. FIGS. 3 to 14 are diagrams illustrating an example of a screen of the information processing apparatus 10 according to an embodiment of the present disclosure.

A screen G illustrated in FIG. 3 is an example of a screen of the touch panel 200 displayed by the information processing apparatus 10. The screen (3 includes a display area 13A in which the cooking process data 130A is displayed in a case where cooking of food C1 is supported. For example, the food C1 is an egg soup. On the screen G, process information 110A, 110B, 1100, 110D, and 110E included in the cooking process data 130A of the food C1 is displayed on the display area 13A. The screen C1 shows the order of execution of the five pieces of process information items 110A, 110B, 110C, 110D, and 110E of the food C1. The process information 110A is information indicating a process of slicing a quarter of an onion. In other words, the process information 110A includes the task information indicating that the onion is sliced and the material information indicating a quarter of the onion. Then, the process information 110B is information indicating a process of adding the sliced onion to a consomme soup and heating it. The process information 1100 is information indicating a process of mixing two eggs. The process information 110D is information indicating a process of adding a liquid mixture of starch and water and egg to the consomme soup and heating it. The process information 110E is information indicating a plating process. Since all pieces of process information 110A, 110B, 110C, 110D, 110E of the food C1 are displayed, the screen G can make the cooking person CP grasp all steps of the food and an execution order. In a case where cooking of a plurality of foods is supported, the screen G is configured to have a plurality of display areas 13A for a plurality of food items. In the following description, in a case where the process information 110A, 110B, 110C, 110D, 110E, and the like are not distinguished from each other, they are referred to as process information 110.

On the screen G, appliance information 130 indicating the cooking appliance used in the cooking of the cooking process indicated by the process information 110A is displayed in association with the process information 110A. On the screen G, tool information 120A indicating the cooking tool used in the cooking of the cooking process indicated by the process information 110E is displayed in association with the process information 110B. On the screen G, in the cooking process indicated by the process information 110C, the tool information 120A is displayed in association with the process information 110C since the cooking tool of the cooking process indicated by the process information 110B is continuously used. On the screen G, tool information 120B indicating the cooking tool used in the cooking of the cooking process indicated by the process information 110C is displayed in association with the process information 110C. On the screen G, since the cooking tool is not used in the process indicated by the process information 110E, only the process information 110E is displayed. In the following description, in a case where the tool information 120A, 120B, and the like are not distinguished, they are referred to as tool information 120. In an embodiment of the present disclosure, the example in which the tool information 120 is superimposed on part of the process information 110 on the screen G has been described, but the present disclosure is not limited thereto. For example, on the screen G, the tool information 120 may be included in the process information 110.

The screen G includes a display area 133 in which the cooking tool data 130B is displayed and a display area 13C in which the cooking appliance data 130C is displayed. On the screen G, an icon or the like indicating the tool information of the cooking tool data 130B is displayed in the display area 13B. On the screen G, an icon or the like indicating the appliance information of the cooking appliance data 130C is displayed in the display area 13C. In the example illustrated in FIG. 3, on the screen G, information indicating that the cooking tool includes three pans, two pots and two bowls and the usage situation of each cooking tool are displayed in the display area 13B. Then, on the screen G, information indicating that the cooking appliance includes one cutting board and four stoves, and the usage situation of each cooking appliance are displayed in the display area 13C. As a result, the cooking person CP can check the usage situation of cooking tool and the cooking appliance by viewing the screen G.

In an embodiment of the present disclosure, the example in which the display area 13B displaying the cooking tool data 130B and the display area 13C displaying the cooking appliance data 130C are set above the display area 13A displaying the cooking process data 130A on the screen G has been described, but the present disclosure is not limited thereto. Further, on the screen G, an icon 610 is displayed at the lower corner. The icon G10 is, for example, an icon for executing an application program for performing input, change, selection, and the like related to the screen G.

in a situation illustrated in FIG. 3, the information processing apparatus 10 has started to support the cooking of the food C1. The information processing apparatus 10 causes the process information 110A, 110B, 110C, 110D, and 110E to be displayed in the display area 13A of the screen C1 on the basis of the cooking process data 130A of the food C1. Then, the information processing apparatus 10 causes the executable process information 110A and 110C to be displayed on the screen C in a display form different from the display form of the process information 110B, 110D, and 110E scheduled to be executed. As a result, the information processing apparatus 10 can cause the cooking person CP to recognize the order of the entire cooking process of the food C1 with reference to the screen G of the touch panel 200 and to recognize that the cooking process of the process information 110A and 110C can be executed.

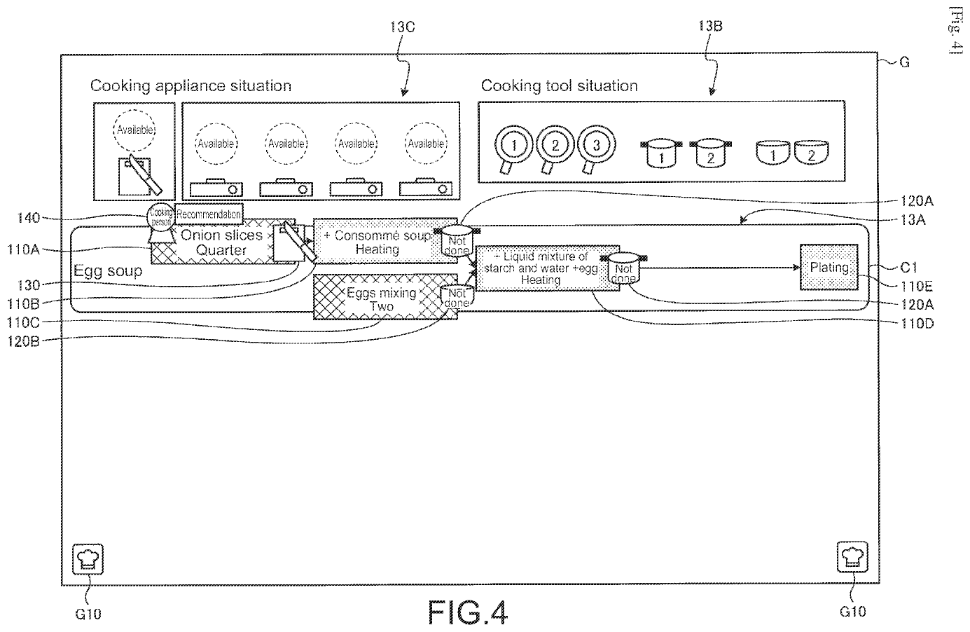

In a situation illustrated in FIG. 4, the information processing apparatus 10 estimates that it is cooking at which the cooking robot 400 is bad through the estimating section 19. Then, the information processing apparatus 10 causes cooking person information 140 to be displayed in the display area 13A of the screen G in association with the process information 110A together with information indicating that the cooking person CP is recommended. As a result, the information processing apparatus 10 can cause the cooking person CP to execute the cooking process of the process information 110A by the cooking person CP with reference to the screen G of the touch panel 200.

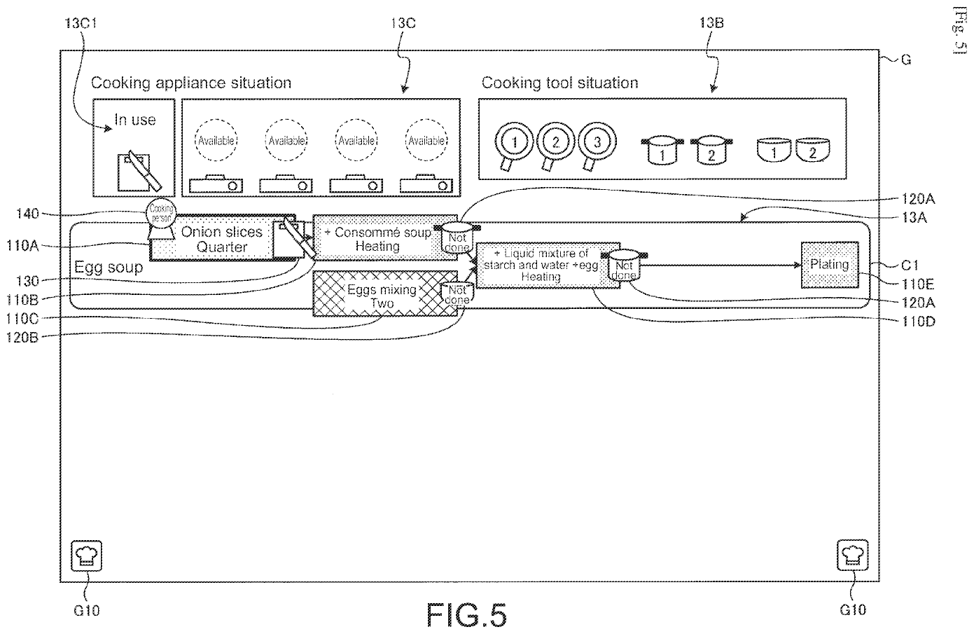

In a situation illustrated in FIG. 5, the information processing apparatus 10 detects that the cooking of the process information 110A is being performed on the basis of the motion of the cooking person CP of slicing an onion by the detecting section 15. The information processing apparatus 10 removes information indicating that the cooking person CP of the cooking person information 140 is recommended. The information processing apparatus 10 detects that the cooking appliance of the appliance information 13C1 is in use by the usage situation detecting section 16. Then, the information processing apparatus 10 changes the display form indicating that it is being executed to the display form of the process information 110A of the screen G. The information processing apparatus 10 changes display of appliance information 13C1 to indicate that it is in use. As a result, the information processing apparatus 10 can indicate information indicating that the cooking process indicated by the process information 110A of the food C1 is being executed, and the cooking appliance of the appliance information 13C1 is in use on the screen G of the touch panel 200.

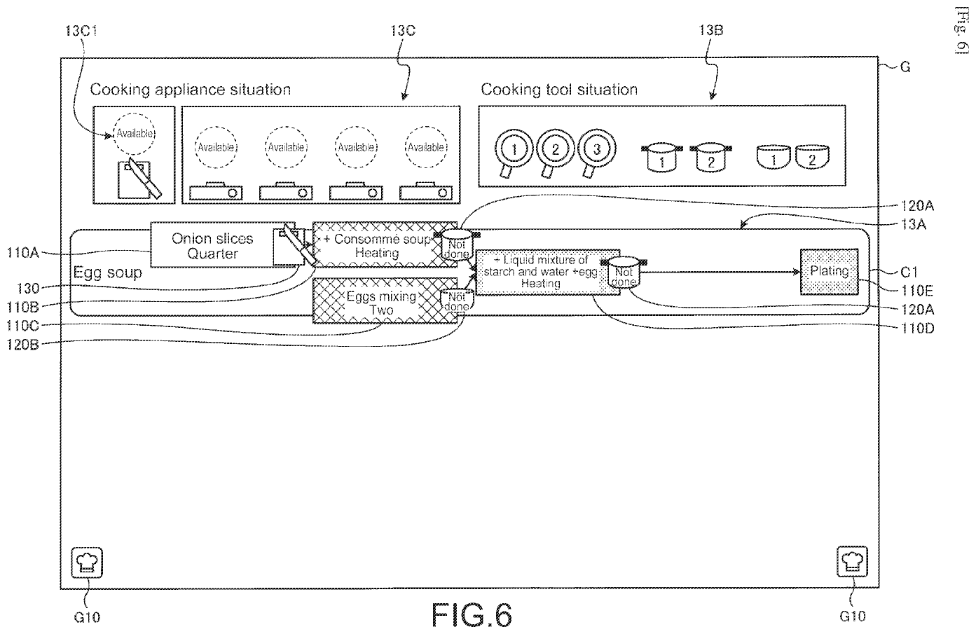

In a situation illustrated in FIG. 6, the information processing apparatus 10 detect that the cooking of the process information 110A is being performed on the basis of motions of transferring the onion sliced by the cooking person CP to the pan and leaving the cooking appliance or the like through the detecting section 15. The information processing apparatus 10 causes the executable process information 110B and 110C to be displayed on the screen G in a display form different from the display form of the process information 110D and 110E scheduled to be executed. As a result, the information processing apparatus 10 can cause the cooking person CP to recognize that the process information 110B and 110C can be executed with reference to the screen G of the touch panel 200.

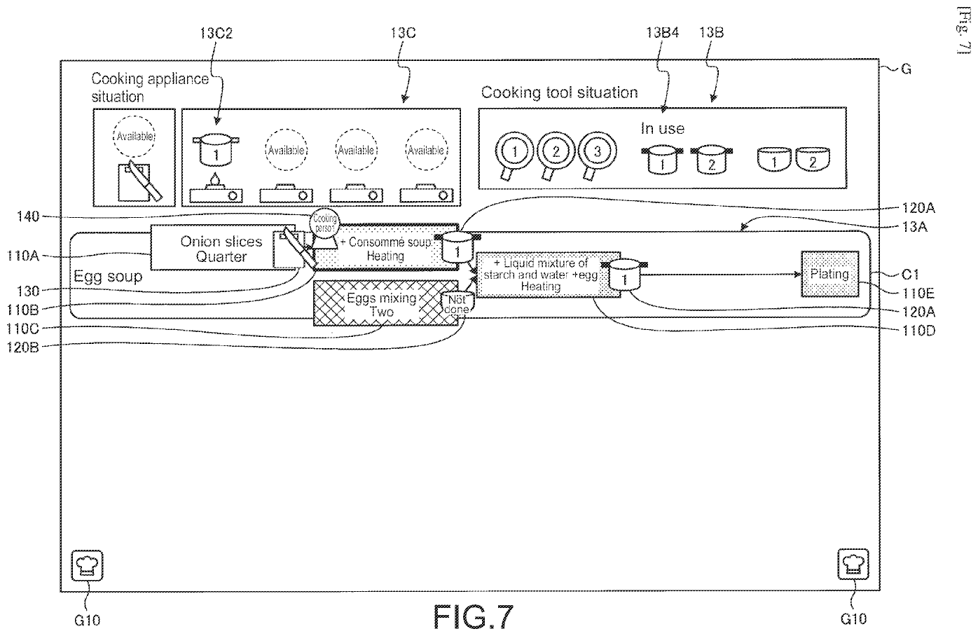

In a situation illustrated in FIG. 7, the information processing apparatus 10 detects that the cooking of the process information 110B is being performed on the basis of motions of putting an onion sliced by the cooking person CP into the pan and heating it by the detecting section 15. The information processing apparatus 10 detects that a cooking appliance of appliance information 13C2 is in use by the usage situation detecting section 16. The information processing apparatus 10 detects that a cooking tool of the tool information 13B4 is in use by the usage situation detecting section 16. Then, the information processing apparatus 10 changes the display form of the process information 110B of the screen G to the display form indicating that it is being executed. The information processing apparatus 10 causes the cooking person information 140 to be displayed in the display area 13A of the screen G in association with the process information 110B. The information processing apparatus 10 changes the display so that the tool information 120A associated with the process information 110B and the process information 110D indicates the appliance information 13C2. The information processing apparatus 10 changes the display of the tool information 13B4 to indicate that it is in use. As a result, the information processing apparatus 10 can indicate that the cooking process indicated by the process information 110B of the food C1 is being executed, and the cooking appliance of the appliance information 13C1 is in use on the screen G of the touch panel 200.

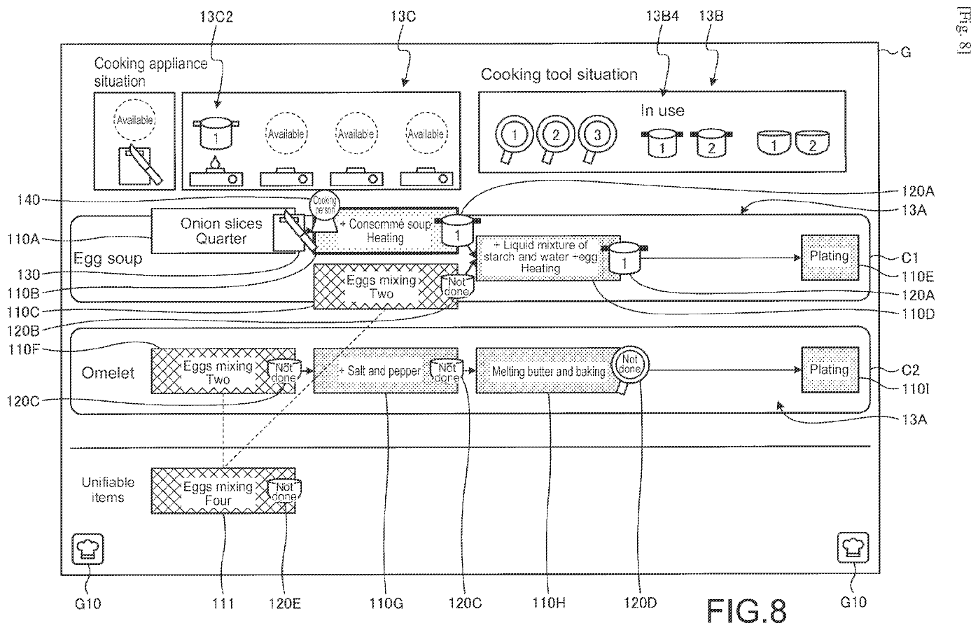

In a situation illustrated in FIG. 8, the information processing apparatus 10 receives an order of food C2 indicating an omelet from the food order terminal 500. The information processing apparatus 10 acquires the cooking process data 130A of the food. C2. The information processing apparatus 10 causes the process information 1101, 110G, 110H, and 110I to be displayed on the new display area 13A of the screen G on the basis of the cooking process data 130A of the food C2. The information processing apparatus 10 changes the display of the screen G so that the display area 13A of the food C2 is added below the display area 13A of the food C1. The information processing apparatus 10 causes the executable process information 110F to be displayed in the display area 13A of the food C2 in a display form different from the process information 110G, 110H, and 110I scheduled to be executed.

The information processing apparatus 10 extracts the process information 110C of the food C1 and the process information 110E of the food C2 as items which can be communized by the extracting section 18. Then, the information processing apparatus 10 causes unification information 111 obtained by unifying the process information 110C of the food C1 and the process information 110F of the food C2 to be displayed on the screen G in association with the process information 110C and the process information 110F. The information processing apparatus 10 changes a display form of the unification information 111 of the screen G to the display form indicating that it is being executed. As a result, the information processing apparatus 10 can cause the cooking person CP recognizing the screen G of the touch panel 200 to recognize that the unification information 111 is present as an item unifiable in the food C1 and the food C2. Note that in an embodiment of the present disclosure, the information processing apparatus 10 connects the unification information 111 to each of the process information 110C of the food C1 and the process information 110F of the food C2 through a straight line and uses the same display color, but the present disclosure is not limited thereto.

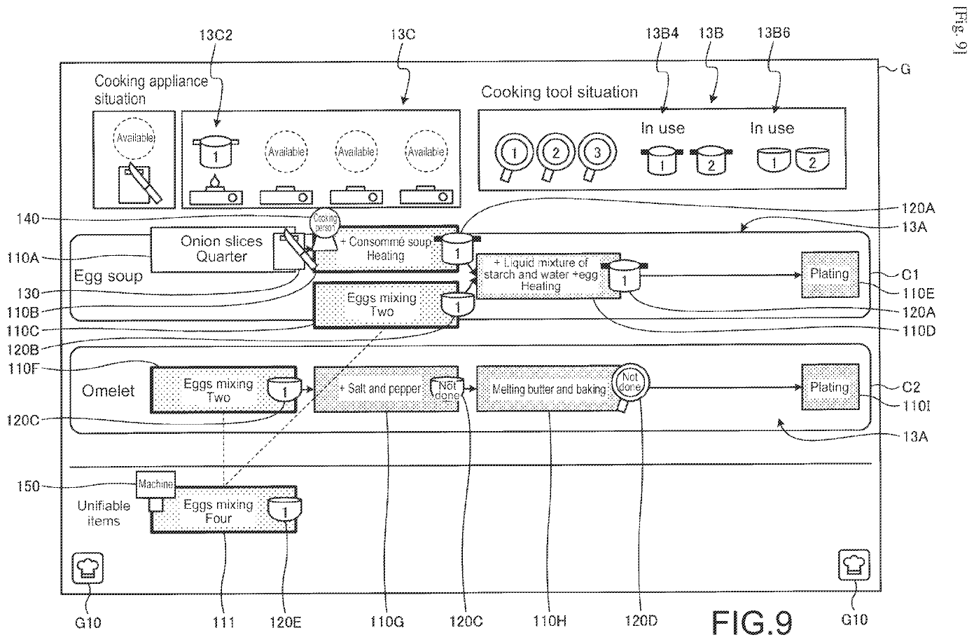

In a situation illustrated in FIG. 9, the information processing apparatus 10 specifies that the cooking robot 400 is to perform the cooking process indicated by the unification information 111 through the specifying section 12. The information processing apparatus 10 detects that a cooking tool of tool information 13B6 is in use by the usage situation detecting section 16. Then, the information processing apparatus 10 changes the display form of the unification information 111 of the screen G and the process information 110C and the process information 110F associated with the unification information 111 to the display form indicating that it is being executed. The information processing apparatus 10 causes robot information 150 indicating the cooking robot 400 to be displayed on the screen G in association with the unification information 111.

The information processing apparatus 10 changes display of the tool information 13B6 to indicate that it is in use. As a result, the information processing apparatus 10 can cause the cooking person CP viewing the screen G of the touch panel 200 to recognize that the cooking person CP is executing the cooking process indicated by the process information 110B of the food C1, and the cooking robot 400 is executing the cooking process indicated by the unification information 111.

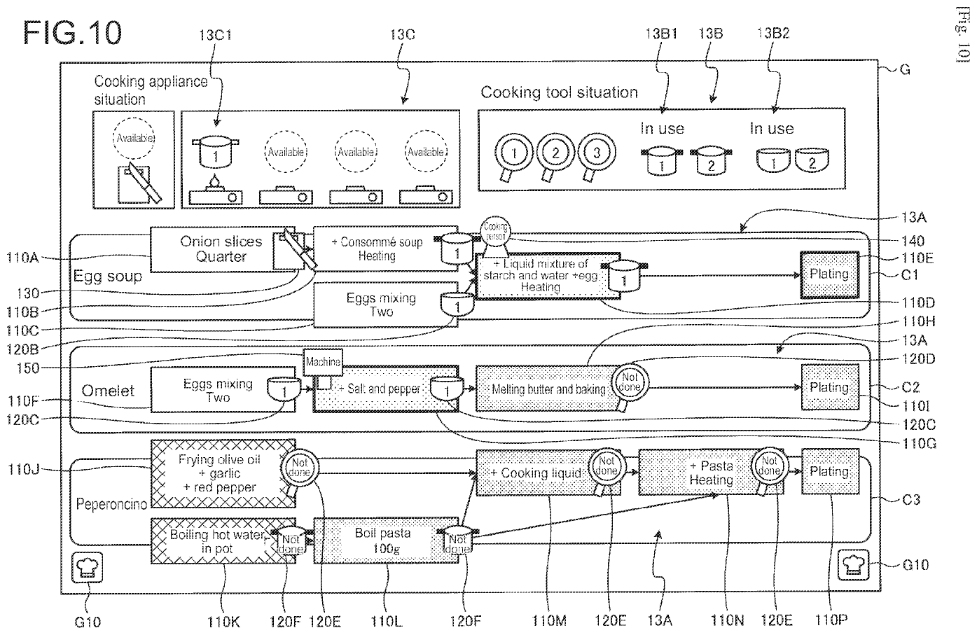

A situation illustrated in FIG. 10 is a situation after the cooking process of the unification information 111 of the situation illustrated in FIG. 9 ends, the unification information 111 is deleted from the screen G, and the execution of the process information 110C of the food C1 and the process information 110E of the food C2 ends.

In the situation illustrated in FIG. 10, the information processing apparatus 10 specifies that the cooking robot 400 is to perform the cooking process indicated by the process information 1106 of the food C2 by the specifying section 12. The information processing apparatus 10 causes the process information 110D of the food C1 and the process information 110G of the food C2 to be displayed on the screen G in a display form indicating that it is being executed. The information processing apparatus 10 causes the cooking person information 140 and the robot information 150 to be displayed on the screen 6 in association with the process information 110D of the food C1 and the process information 110G of the food C2, respectively. Then, information processing apparatus 10 receives an order of food C3 indicating peperoncino from the food order terminal 500. The information processing apparatus 10 acquires the cooking process data 130A of the food C3. The information processing apparatus 10 causes the process information 110J, 110K, 110L, 110M, 110N, and 110P to be displayed in the new display area 13A of the screen G on the basis of the cooking process data 130A of the food C3. The information processing apparatus 10 changes the display of the screen G so that the display area 13A of the food C3 is added below the display area 13A of the food C1 and the food C2. The information processing apparatus 10 causes the executable process information 110 and 110K and the process information 110L, 110M, 110N, and 110P scheduled to be executed to be displayed in the display area 13A of the food C3 in a different display form.

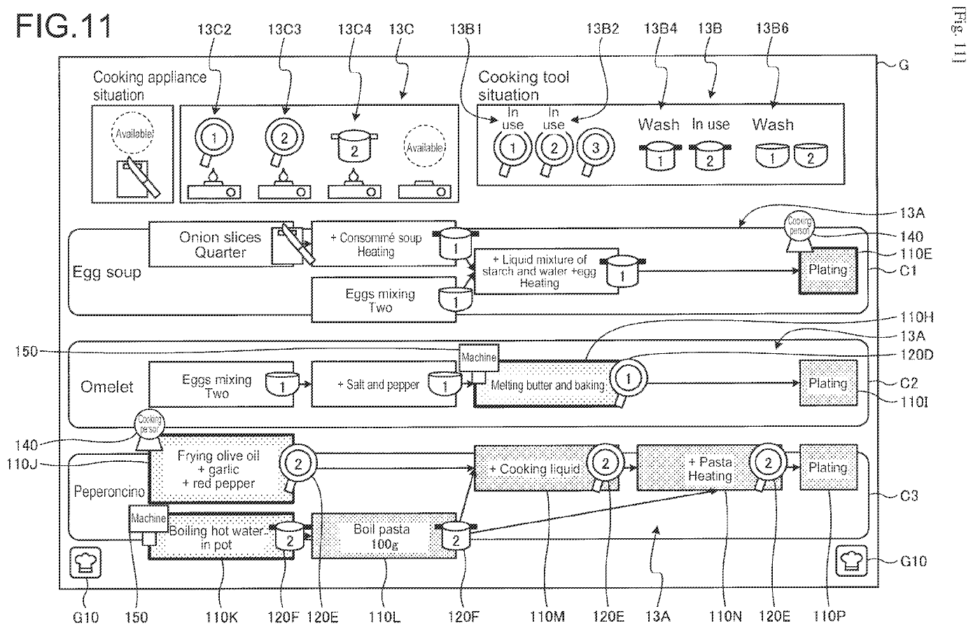

In a situation illustrated in FIG. 11, the information processing apparatus 10 detects that the cooking person CP is performing the cooking indicated by the process information 110E of the food C1 and the cooking indicated by the process information 110J of the food C3 in parallel by the detecting section 15. The information processing apparatus 10 detects that the cooking robot 400 is performing the cooking indicated by the process information 110H of the food C2 and the cooking indicated by the process information 110K of the food C3 in parallel by the detecting section 15. The information processing apparatus 10 detects that tool information 13B1, 13B2, and 13B5 is in use, and tool information 13B4 and 13B6 is being washed by usage situation detecting section 16. Then, the information processing apparatus 10 causes the process information 110E of the food C1, the process information 110H of the food C2, and the process information 110J and the process information 110K of the food C3 to be displayed on the screen G in a display form indicating that it is being executed. The information processing apparatus 10 causes the cooking person information 140 and the robot information 150 to be displayed on the screen G in association with the process information 110E and the process information 110J and the process information 110H and the process information 110K, respectively. In other words, the information processing apparatus 10 causes a plurality of pieces of cooking person information 140 and a plurality of pieces of robot information 150 to be displayed on the screen G. Further, the information processing apparatus 10 changes the display of the tool information 13B4 and 13B6 to indicate that cleaning is in progress. As a result, the information processing apparatus 10 can cause the other cooking persons CP or the like viewing the screen G of the touch panel 200 to recognize that the cooking person CP, cooking robot 400, and the like are executing a plurality of cooking processes.

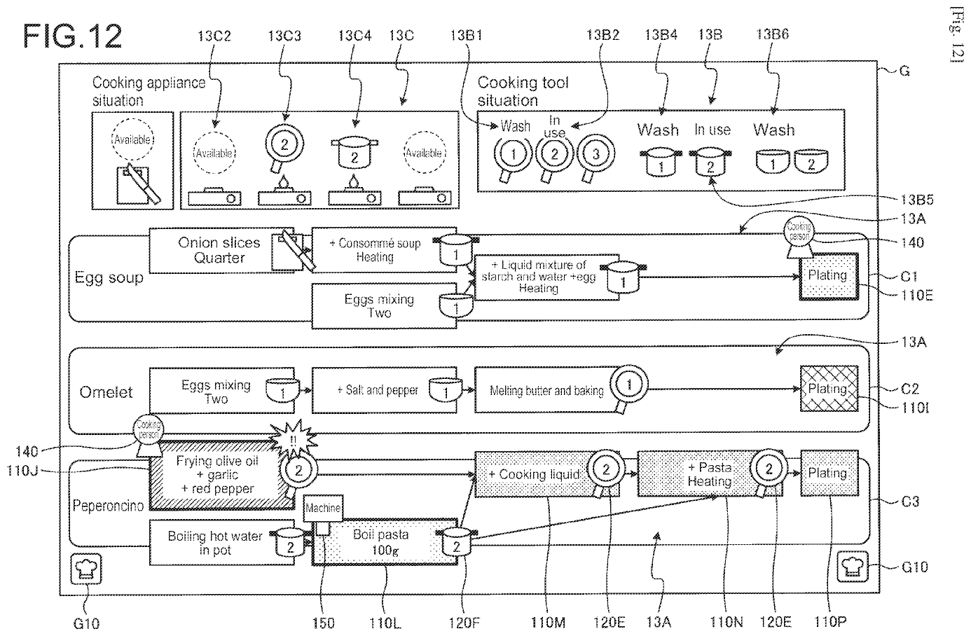

In a situation illustrated in FIG. 12, the information processing apparatus 10 detects the occurrence of an abnormality in the cooking process indicated by the process information 110J on the basis of a delay of an elapsed time in the cooking process of the food C3, generation of smoke from the cooking tool, or the like by the detecting section 15. Then, the information processing apparatus 10 changes the display form indicating that the process information 110J is being executed to a display form of an alert. In an embodiment of the present disclosure, for example, the information processing apparatus 10 adds alert information indicating an alert “!!” to the process information 110J. As a result, information processing apparatus 10 can alert the occurrence of an abnormality by indicating that an abnormality has occurred in the cooking process indicated by the process information 110J of the food C3 on the screen G of the touch panel 200. Note that, in an alert method, for example, an alert display may be changed in accordance with the passage of time, or an alert sound may be output together with the alert display.

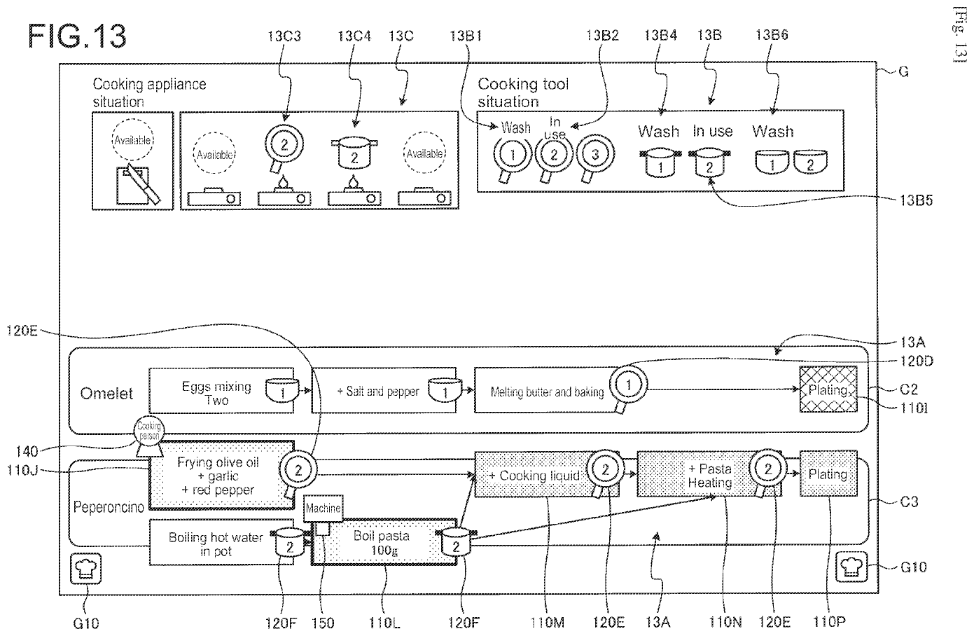

In a situation illustrated in FIG. 13, the information processing apparatus 10 detects a motion of redoing the cooking process in which the occurrence of an abnormality is detected by the detecting section 15, a motion of redoing by the cooking person CP, and the like. The information processing apparatus 10 detects that the cooking of the food C1. is completed, Then, the information processing apparatus 10 causes the display area 13A of the food C1 to be removed from the screen G. The information processing apparatus 10 changes the display form of the alert of the process information 110J to the display form indicating that it is being executed. As a result, the information processing apparatus 10 can cause the cooking person CP or the like viewing the screen C1 of the touch panel 200 to recognize that the food C1 is completed. Note that the information processing apparatus 10 may cause the display area 13A of the food C2 and the food C3 to be moved above the screen G in response to the erasing of the display area 13A of the food C1.

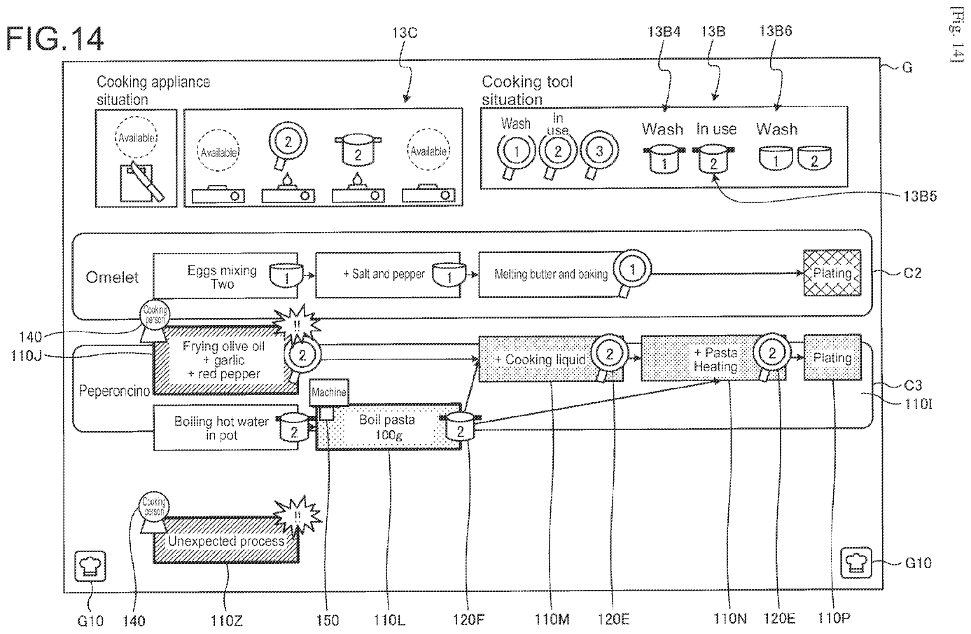

In a situation illustrated in FIG. 14, the information processing apparatus 10 detects the occurrence of an abnormality indicating that the cooking person CP mistakes, for example, a material or a quantity or mistakes cooking contents in the cooking process indicated by the process information 110J of the food C3 by the detecting section 15. The information processing apparatus 10 detects cooking which is different from the cooking process indicated by the process information 110J in which the cooking person CP is displayed on the screen G. Then, the information processing apparatus 10 changes the display form indicating that the process information 110J is being executed to the display form of the alert. The information processing apparatus 10 causes unexpected information 1102 indicating an unexpected cooking process to be displayed on the screen G. As a result, the information processing apparatus 10 can alert the occurrence of the unexpected cooking process by indicating that the cooking person CP is executing the unexpected cooking process on the screen G of the touch panel 200.

### <Estimation Method of Information Processing Apparatus According to Embodiments>

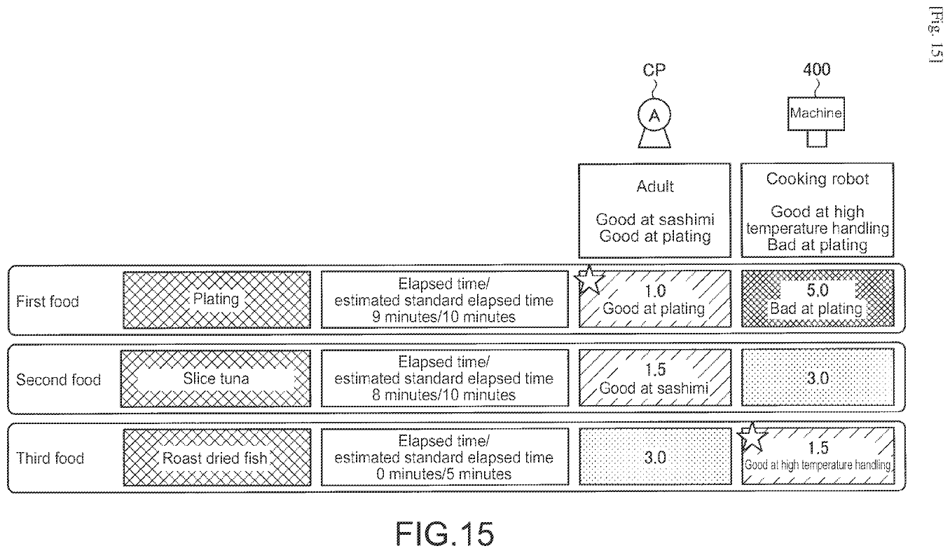

Next, an example of an estimation method of the information processing apparatus 10 according to an embodiment of the present disclosure will be described with reference to FIGS. 15 to 20. FIGS. 15 to 20 are diagrams illustrating an example of the estimation method of the information processing apparatus 10 according to an embodiment of the present disclosure.

In the example illustrated in FIG. 15, the information processing apparatus 10 acquires information related to the cooking process scheduled to be executed, the elapsed time, and an estimated standard elapsed time for each of the first food, the second food, and the third food. The information processing apparatus 10 sets the cost of the cooking person CP of each of the first food, the second food, and the third food on the basis of the profile of the cooking person data 130D. For example, the profile of the cooking person CP indicates that the cooking person CP is good at cooking of sashimi and plating. In this case, the information processing apparatus 10 performs settings in which the cost of the first food of the cooking person CP is 1.0, the cost of the second food is 1.5, and the cost of the third food is 3.0 using a setting method of setting the cost in combination of the cooking process and the elapsed time. Note that the cost means that the cooking person CP is specialized in or likes food with lower cost. Examples of the setting method include a method of setting using a database and a profile and a method of using an application program for setting the cost on the basis of a cooking process and a profile. Further, for example, the profile of the cooking robot 400 indicates that the cooking robot 400 is good at handling high temperature food and is not good at plating. In this case, the information processing apparatus 10 performs settings in which the cost of the first food of the cooking robot 400 is 5.0, the cost of the second food is 3.0, and the cost of the third food is 1.5 using the setting method described above. Then, the information processing apparatus 10 estimates the cooking process at which the cooking robot 400 is not good on the basis of the cost of the cooking robot 400. In the example illustrated in FIG. 15, the information processing apparatus 10 estimates that the cooking process of the first food which is high in the cost of the cooking robot 400 as a cooking process at which the cooking robot 400 is not good. As a result, the information processing apparatus 10 specifies that the cooking person CP is to perform the cooking process of the first food, and the cooking robot 400 is to perform the cooking process of the third food.

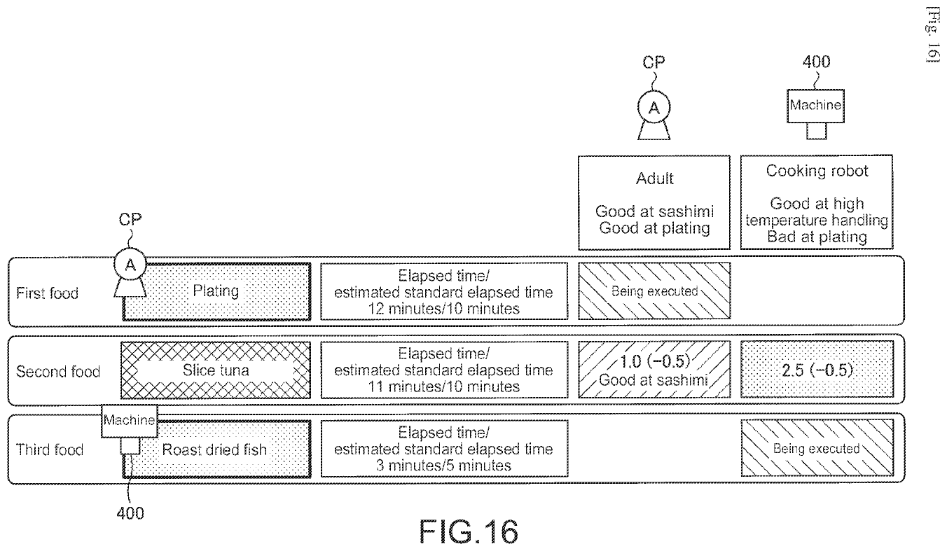

An example illustrated in FIG. 16 indicates a case in which the cooking person CP and the cooking robot 400 are executing the cooking process illustrated in FIG. 15. The information processing apparatus 10 adjusts the costs of the cooking person CP and the cooking robot 400 set in the second food in the example illustrated in FIG. 15. Specifically, if it is detected that the elapsed times of the first food and the second food are later than the estimated standard elapsed time, the information processing apparatus 10 lowers the cost of the cooking process of the second food scheduled to be executed in order to increase a priority. For example, the information processing apparatus 10 lowers the cost of the cooking person CP of the cooking process of the second food to 1.0 and lowers the cost of the cooking robot 400 to 2.5 on the basis of the delay time of the elapsed time. For example, the information processing apparatus 10 may lower the cost by 0.5 each time the elapsed time is delayed by one minute. The information processing apparatus 10 can increase a possibility of responsibility for the cooking cost by lowering the costs of the cooking process of the cooking person CP and the cooking robot 400.

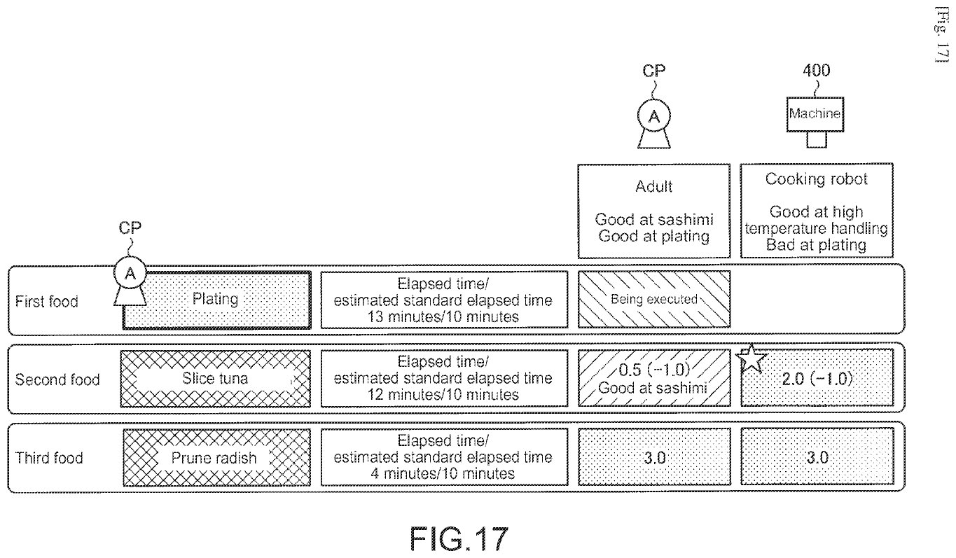

In an example illustrated in FIG. 17, the cooking process of the third food illustrated in FIG. 16 is completed by the cooking robot 400, and the next cooking process is selected for the third food. The information processing apparatus 10 performs settings in which the cost of the third food of the cooking person CP is 3.0, and the cost of the third food of the cooking robot 400 is 3.0. The information processing apparatus 10 compares the cost of the second food and the cost of the third food of the cooking robot 400 because the cooking person CP is executing the cooking process, and specifies that the cooking robot 400 is to perform the cooking process of the second food with lower cost.

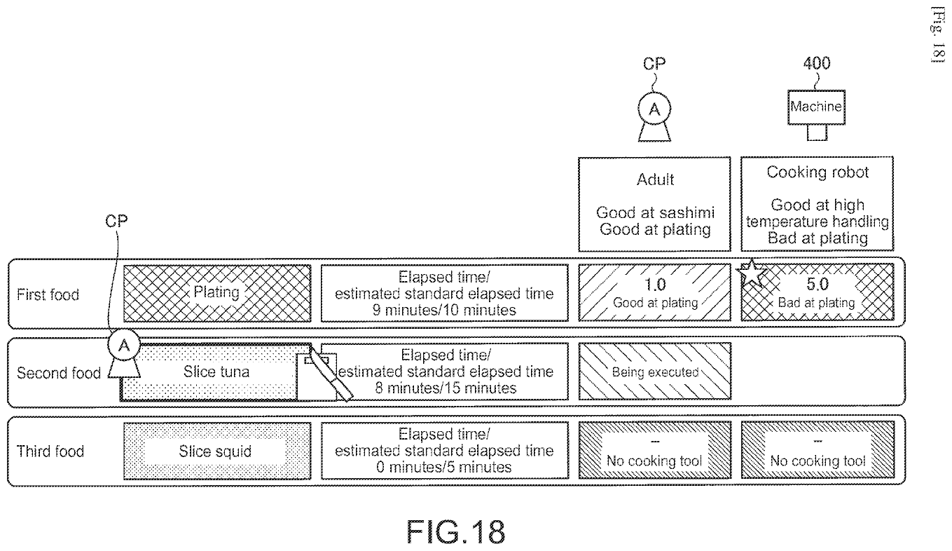

In an example illustrated in FIG. 18, the cooking person CP is executing the cooking process of the second food and using the cooking appliance. The information processing apparatus 10 performs settings in which the cost of the first food of the cooking person CP is 1.0, and the cost of the first food of the cooking robot 400 is 5.0. Further, the cooking process of the third food is a cooking process in which the cooking appliance used in the cooking process of the second food is used. In this case, the information processing apparatus 10 does not set the cost of the cooking process of the third food. Then, the information processing apparatus 10 indicates that the cooking process of the first food is a cooking process at which the cooking robot 400 is had using the cost, but there is no other cooking process to be selected, the information processing apparatus 10 specifies that the cooking robot 400 is to perform the cooking process of the first food.

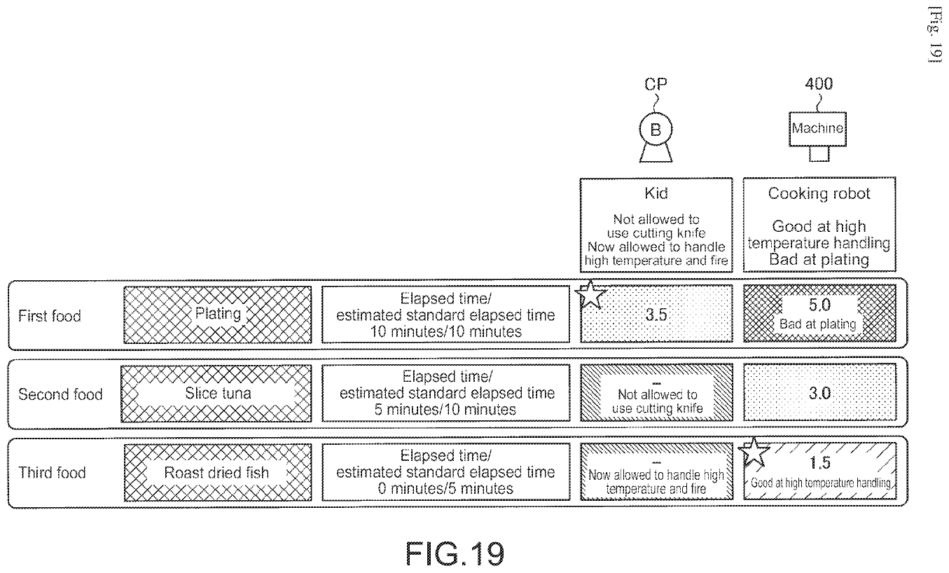

In an example illustrated in FIG. 19, the cooking person CP is a kid, and the cooking processes of the second food and the third food are the tasks using the cutting knife of the cooking appliance. For example, the profile of the cooking person CP who is a kid indicates that the use of the cutting knife is not allowed, and the handling of the high temperature or the fire is not allowed. In this case, the information processing apparatus 10 sets the cost of the cooking person CP only in the cooking process of the first food, and sets the cost of the cooking robot 400 in the cooking processes of all foods. The information processing apparatus 10 specifies that the cooking person CP who is a kid is to perform the cooking process of the first food. The information processing apparatus 10 specifies that the cooking robot 400 is to perform the cooking process of the third food of the cooking processes of the second food and the third food with lower cost.

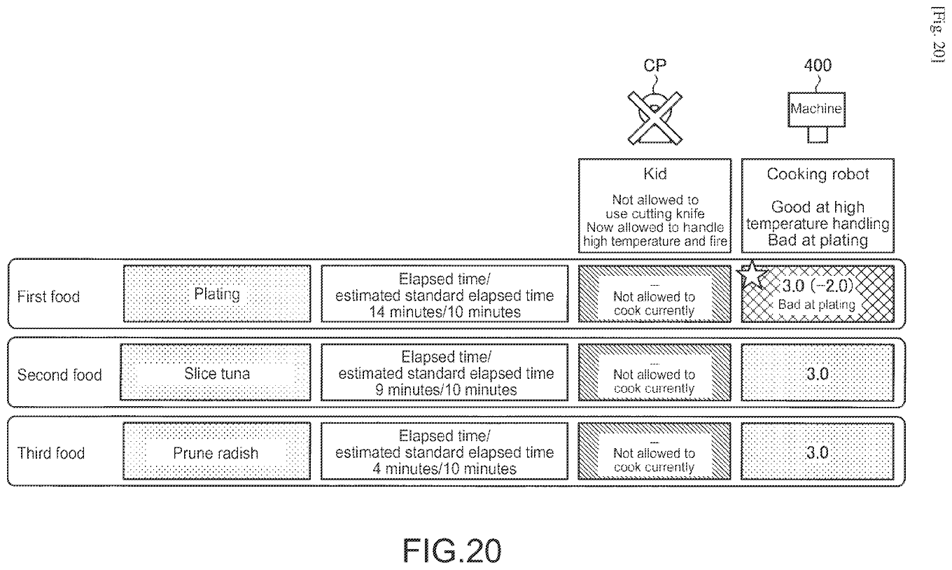

In an example illustrated in FIG. 20, the cooling person CP is a kid. The information processing apparatus 10 detects that cooking is not temporarily performed, for example, on the basis of a state in which the cooking person CP does not perform cooking for a certain period of time, detection of a motion different from cooking, or the like. In this case, the information processing apparatus 10 set the cost of the cooking robot 400 in the cooking process of all foods without setting the cost of the cooking person CP. The information processing apparatus 10 specifies that the cooking person CP is to perform the cooking process of the first food. If it is detected that the elapsed time of the first food is later than the estimated standard elapsed time, the information processing apparatus 10 lower the cost of the cooking process of the first food on the basis of the delay time. As a result, the costs of the cooking robot 400 for the first food, the second food, and the third food become the same cost. The information processing apparatus 10 specifies that the cooking robot 400 is to perform the cooking process of the first food since the cooking process of the first food is the cooking process at which the cooking robot 400 is bad, but the elapsed time is delayed.

### <Example of Profile of Information Processing Apparatus According to Embodiments>

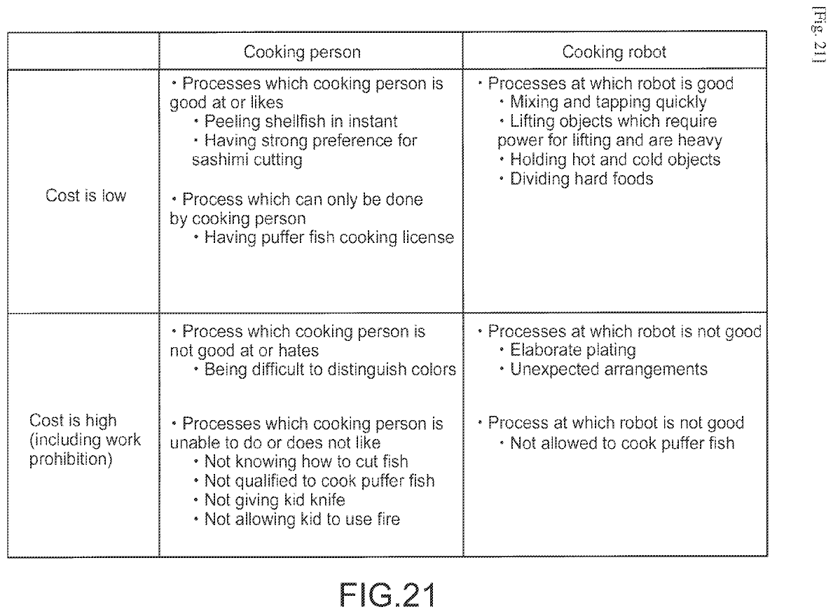

Next, referring to FIG. 21, an example of the profiles of the cooking person CP and the cooking robot 400 of the information processing apparatus 10 according to an embodiment of the present disclosure will be described. FIG. 21 is a diagram illustrating an example of a profile of the information processing apparatus 10 according to an embodiment of the present disclosure.

In the example illustrated in FIG. 21, the profile of the cooking person data 130D indicates that the cost of the process which the cooking person CP is good at or likes and the cost of the process which can only be done by the cooking person CP are set to be low. The process which the cooking person is good at or like includes, for example, peeling shellfish in an instant and having a strong preference for sashimi cutting. The process which can only be done by the cooking person CP includes, for example, having a puffer fish cooking license. Further, the profile of the cooking person data 130D indicates that the costs for the process which the cooking person CP is not good at or hates and the process which the cooking person CP is unable to do or does not like are set to be high. Note that the high cost setting includes, for example, task prohibition. The process which the cooking person CP is not good at or hates include, for example, being difficult to distinguish colors. The process which the cooking person is unable to do or does not like include, for example, not knowing how to cut fish, not qualified to cook puffer fish, not giving kid a knife, not allowing kid to use fire, and the like.

The profile of the robot data 130E indicating that the cost for the process at which the cooking robot 400 is good is set to be low. Examples of the process at which the cooking robot 400 is good includes mixing and tapping quickly, having power and lifting heavy objects, holding hot and cold objects, and dividing hard foods. Further, the profile of the robot data 130E indicates that the cost for the process at which the cooking robot 400 is good and the process which the cooking robot 400 is unable to do is set to be high. Examples of the processes at which the cooking robot 400 is good include elaborate plating and unexpected arrangements. The process which the cooking robot 400 is unable to do includes puffer fish cooking or the like.

### <Processing Procedure of Information Processing Apparatus 10 According to Embodiments>

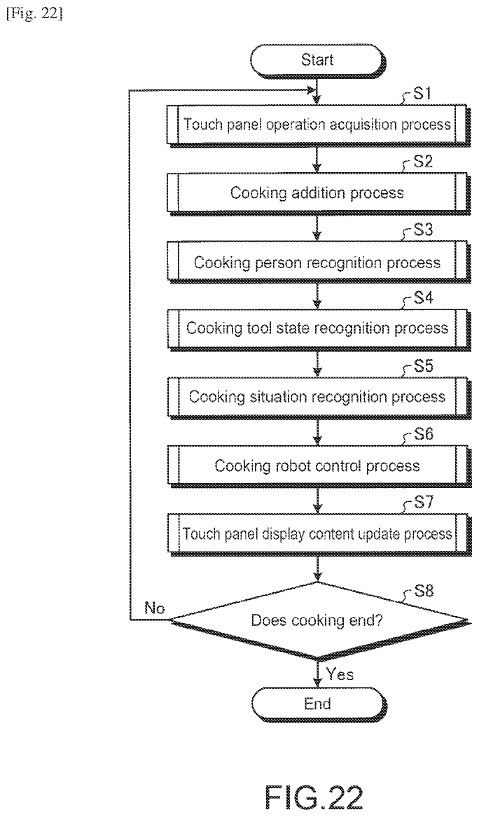

Next, an example of a processing procedure of the information processing apparatus 10 according to an embodiment of the present disclosure will be described. FIGS. 22 to 28 are flowcharts illustrating an example of the processing procedure performed by the information processing apparatus 10 according to an embodiment of the present disclosure. A processing procedure illustrated in FIG. 22 is realized by executing a program by the information processing apparatus 10. The processing procedure illustrated in FIG. 22 is repeatedly executed by the information processing apparatus 10.

As illustrated in FIG. 22, the information processing apparatus 10 executes a touch panel operation acquisition process (step S1). For example, if the information processing apparatus 10 executes the touch panel operation acquisition process, the information processing apparatus 10 determines whether or not there is a touch operation on the basis of the detection result of the touch panel 200. The information processing apparatus 10 stores operation contents in the storage section 13 in a case where there is a touch operation. The information processing apparatus 10 does nothing in a case where there is no touch operation. Then, the information processing apparatus 10 causes the process to proceed to step S2 after the touch panel operation acquisition process ends.

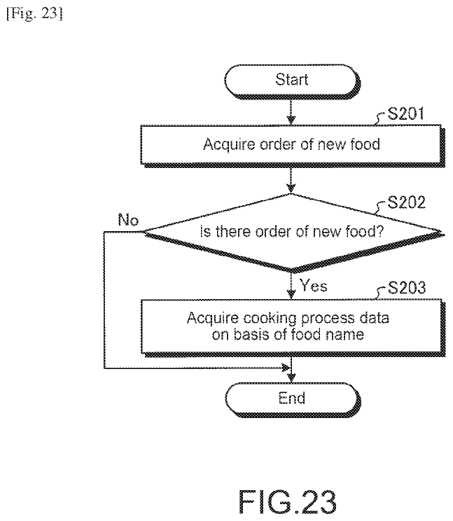

The information processing apparatus 10 executes a cooking addition process (step S2). For example, the information processing apparatus 10 executes a processing procedure illustrated in FIG. 23 if the cooking addition process is executed.

As illustrated in FIG. 23, the information processing apparatus 10 acquires the order of the new food (step S201). For example, the information processing apparatus 10 acquires the order of the new food from the food order terminal 500 via the communication section 14 or acquires the order of the new food from the touch panel 200. Note that the information processing apparatus 10 may acquire, for example, voice data through the sensing apparatus 300 via the communication section 14 and acquire the order from the voice data.

The information processing apparatus 10 determines whether or not there is an order of new food (step S202). In a case where it is determined that there is no order of new food (No in step S202), the information processing apparatus 10 terminates the processing procedure of FIG. 23 and returns to the process of step S2 illustrated in FIG. 22. Further, in a case where it is determined that there is an order of new food (Yes in step S202), the information processing apparatus 10 acquires the cooking process data 130A on the basis of a food name (step S203). For example, the information processing apparatus 10 acquires the cooking process data 130A from the cooking process database 601 of the information processing server 600 or from the storage section 13 via the communication section 14 on the basis of the food name. Then, if the process of step S203 ends, the information processing apparatus 10 terminates the processing procedure of FIG. 23 and returns to the process of step S2 illustrated in FIG. 22.

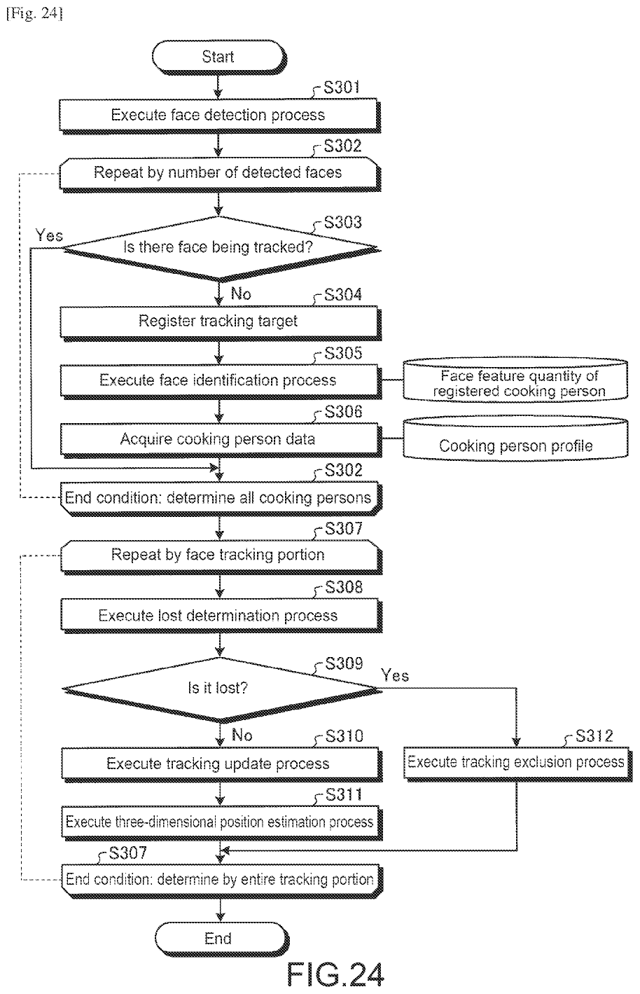

Returning to the processing procedure illustrated in FIG. 22, the information processing apparatus 10 executes a cooking person recognition process (step S3). For example, the information processing apparatus 10 executes a processing procedure illustrated in FIG. 24 if the cooking person recognition process is executed.

As illustrated in FIG. 24, the information processing apparatus 10 executes a face detection process (step S301). For example, the information processing apparatus 10 executes the face detection process and detects the face of the cooking person CP in the cooking room R on the basis of the sensing information (image) of the sensing apparatus 300. The information processing apparatus 10 stores information or the like indicating the number of people who face is detected in the storage section 13.

The information processing apparatus 10 repeats the number of face detections by executing the loop process of step S302. An end condition of step S302 is performing determination for all the cooking persons CP. Then, the information processing apparatus 10 determines whether or not it is a face being tracked (step S303). In a case where it is determined that it is a face being tracked (Yes in step S303), the information processing apparatus 10 repeats the loop process of step S302 if there is any one cooking person CP for whom the determination is not performed. Further, if the determination has been performed for all the cooking persons CP, the information processing apparatus 10 terminates the loop process of step S302 and causes the process to proceed to step S307 to be described later.

Further, in a case where it is determined that there is no face being tracked (No in step S303), the information processing apparatus 10 registers the identified face as a tracking target (step S304). Then, the information processing apparatus 10 executes a face identification process (step S305). For example, the information processing apparatus 10 executes the face identification process, and identifies the face of the cooking person CP in the cooking room R on the basis of the sensing information (sensing) of the sensing apparatus 300 and the feature quantity of the registered face of the cooking person CP. The information processing apparatus 10 stores the identification result in the storage section 13. Then, the information processing apparatus 10 acquires the cooking person data 130D on the basis of the identification result of the storage section 13 (step S306).

If there is any one CP for whom the determination is not performed, the information processing apparatus 10 repeats the loop process of step S302. Further, if the determination has been performed for all the cooking persons CP, the information processing apparatus 10 terminates the loop process of step S302 and causes the process to proceed to step S307. The information processing apparatus 10 repeats it by a tracking portion by executing the loop process of step S307. The tracking portion means, for example, the number of identified faces for which the process related to the tracking is repeated. The end condition of step S307 is performing the determination for all the cooking persons CP whose face is identified.

The information processing apparatus 10 executes a lost determination process (step S308). For example, the information processing apparatus 10 executes the lost determination process, determines whether or not the identified cooking person CP is lost in the cooking room R, and stores the determination result in the storage section 13. Then, if it is determined that it is lost in the lost determination process (No in step S309), the information processing apparatus 10 causes the process to proceed to step S310.

The information processing apparatus 10 executes a tracking update process (step S310). For example, the information processing apparatus 10 updates the tracking result of the identified cooking person CP by performing the tracking update process. Then, the information processing apparatus 10 executes a three-dimensional position estimation process (step S311). For example, the information processing apparatus 10 estimates position information in the cooking room R of the identified cooking person CP by performing a three-dimensional position estimation process, and stores the estimation result in the storage section 13 in a chronological order. Then, if the determination for all the cooking persons CP whose face is identified does not end, the information processing apparatus 10 repeats the loop process of step S307. Further, if the determination for all the cooking persons CP whose face is identified ends, the information processing apparatus 10 terminates the loop process of step S307 and terminates the processing procedure of FIG. 24. Then, the information processing apparatus 10 returns to the process of step S3 illustrated in FIG. 22.

Further, in a case where it is determined that it is lost in the lost determination process (Yes in step S309), the information processing apparatus 10 causes the process to proceed to step S312. The information processing apparatus 10 executes a tracking exclusion process (step S312). For example, the information processing apparatus 10 excludes the identified cooking person CP from the tracking target by performing the tracking exclusion process. Then, if the determination for all the cooking persons CP whose face is identified does not end, the information processing apparatus 10 repeats the loop process of step S307. Further, if the determination for all the cooking persons CP whose face is identified ends, the information processing apparatus 10 terminates the loop process of step S307 and terminates the processing procedure of FIG. 24. Then, the information processing apparatus 10 returns to the process of step S3 illustrated in FIG. 22.

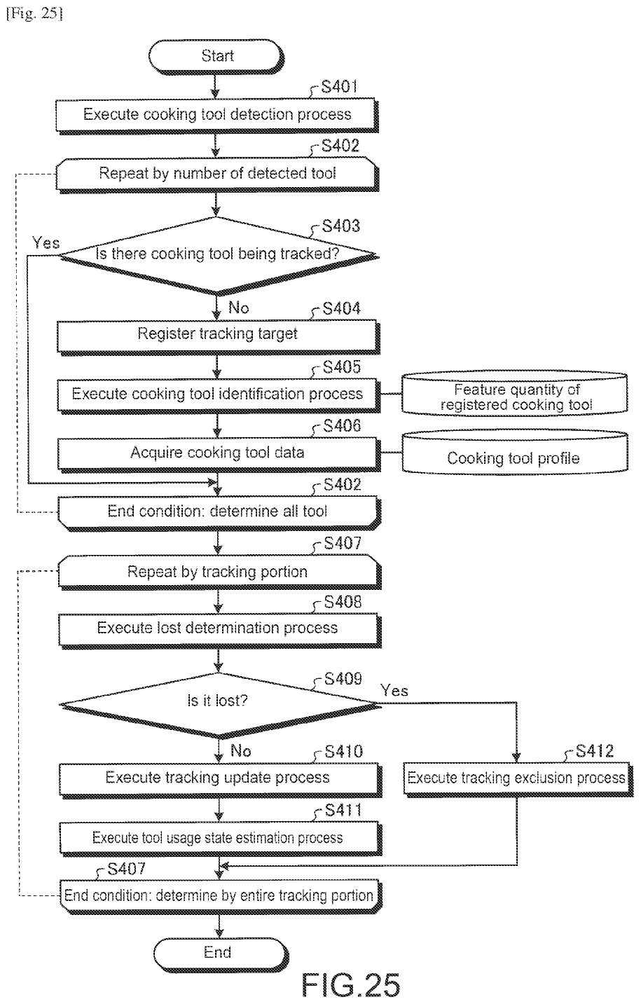

Returning to the processing procedure illustrated in FIG. 22, the information processing apparatus 10 executes a cooking tool state recognition process (step S4). For example, the information processing apparatus 10 executes a processing procedure illustrated in FIG. 25 if the cooking tool state recognition process is executed.

As illustrated in FIG. 25, the information processing apparatus 10 executes a cooking tool detection process (step S401). For example, the information processing apparatus 10 executes the cooking tool detection process and detects the cooking tool in the cooking room R on the basis of the sensing information (sensing) of the sensing apparatus 300 and the profile of the cooking tool data 130B. The information processing apparatus 10 stores information or the like indicating the number of detected cooking tool in the storage section 13.

The information processing apparatus 10 repeats it by the number of detected tool by executing the loop process of step S402. The end condition of step S302 is performing determination for all the cooking tools. Then, the information processing apparatus 10 determines whether or not there is a cooking tool being tracked (step S403). In a case where it is determined that there is a cooking tool being tracked (Yes in step S403), the information processing apparatus 10 repeats the loop process of step S402 if the determination has not been performed for all the cooking tools. Further, if the determination has been performed for all the cooking tools, the information processing apparatus 10 terminates the loop process of step S402 and causes the process to proceed to step S407.

Further, in a case where it is determined that there is no cooking tool being tracked (No in step S403), the information processing apparatus 10 registers the cooking tool as a tracking target (step S404). Then, the information processing apparatus 10 executes a cooking tool identification process (step S405). For example, the information processing apparatus 10 executes the cooking tool identification process, and identifies the cooking tool in the cooking room R on the basis of the sensing information (sensing) of the sensing apparatus 300 and the registered feature quantity of the cooking tool. The information processing apparatus 10 stores the identification result of the cooking tool in the storage section 13. Then, the information processing apparatus 10 acquires the cooking tool data 130B on the basis of the identification result of the storage section 13 (step S406).

If the determination has not been performed for all the cooking tools, the information processing apparatus 10 repeats the loop process of step S402. Further, if the determination has been performed for all the cooking tools, the information processing apparatus 10 terminates the loop process of step S402 and causes the process to proceed to step S407. The information processing apparatus 10 repeats it by a tracking portion by executing the loop process of step S407. The tracking portions means, for example, the number of cooking devices for which the process related to the tracking is repeated. The end condition of step S307 is performing determination for the entire identified tracking portion.

The information processing apparatus 10 executes a lost determination process (step S408). For example, the information processing apparatus 10 executes the lost determination process, determines whether or not the identified cooking device is lost in the cooking room R, and stores the determination result in the storage section 13. Then, if it is determined that it is lost in the lost determination process (No in step S409), the information processing apparatus 10 causes the process to proceed to step S410.

The information processing apparatus 10 executes a tracking update process (step S410). For example, the information processing apparatus 10 updates the tracking result of the identified cooking tool by performing the tracking update process. Then, the information processing apparatus 10 executes a three-dimensional position estimation process (step S411). For example, the information processing apparatus 10 estimates position information in the cooking room R of the identified cooking person CP by performing a three-dimensional position estimation process, and stores the estimation result in the storage section 13 in a chronological order. Then, the information processing apparatus 10 repeats the loop process of step S407 in a case where the determination for all the tracking has not been completed. Further, if the determination for the entire tracking portion ends, the information processing apparatus 10 terminates the loop process of step S407 and terminates the processing procedure of FIG. 25. Then, the information processing apparatus 10 returns to the process of step S4 illustrated in FIG. 22.

Further, in a case where it is determined that it is lost in the lost determination process (Yes in step S409), the information processing apparatus 10 causes the process to proceed to step S412. The information processing apparatus 10 executes a tracking exclusion process (step S412). For example, the information processing apparatus 10 excludes the identified cooking tool from the tracking target by performing the tracking exclusion process. Then, the information processing apparatus 10 repeats the loop process of step S407 in a case where the determination for all the tracking has not been completed. Further, if the determination for the entire tracking portion ends, the information processing apparatus 10 terminates the loop process of step S407 and terminates the processing procedure of FIG. 25. Then, the information processing apparatus 10 returns to the process of step S4 illustrated in FIG. 22.

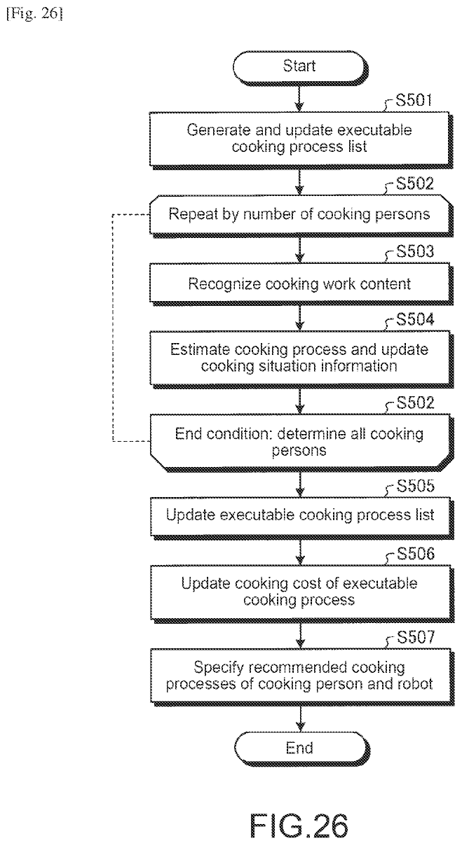

Returning to the processing procedure illustrated in FIG. 22, the information processing apparatus 10 executes a cooking situation recognition process (step S5). For example, the information processing apparatus 10 executes a processing procedure illustrated in FIG. 26 if the cooking situation recognition process is executed.

As illustrated in FIG. 26, the information processing apparatus 10 generates and updates an executable cooking process list (step S501). The cooking configuration list is, for example, a list of cooking processes of the cooking processes of the food, which are executable by the cooking person CP. For example, the information processing apparatus 10 generates and updates the executable cooking process list on the basis of the cooking process data 130A of the food displayed on the screen G.

The information processing apparatus 10 repeats a series of processes by the number of cooking persons by executing the loop process of step S502. The end condition of step S502 is performing determination for all the cooking persons CP. Then, the information processing apparatus 10 recognizes cooking task contents (step S503). For example, the information processing apparatus 10 recognizes task contents performed by the cooking person CP by the detecting section 15. Then, the information processing apparatus 10 executes a cooking status information update process (step S504). For example, the information processing apparatus 10 executes the cooking status information update process, detects the cooking process being performed by the cooking person CP, the completed cooking process, and whether or not any abnormality occurs or the like by the detecting section 15, and update the situation. The information processing apparatus 10 stores the updated cooking status information in the storage section 13.

The information processing apparatus 10 repeats the loop process of step S504 in a case where the process of step S504 ends, and there is any one cooking person CP for which the process does not end. Further, if the process ends for all the cooking persons CP, the information processing apparatus 10 terminates the loop process of step S504 and causes the process to proceed to step S505.

The information processing apparatus 10 updates the executable cooking process list (step S505). For example, the information processing apparatus 10 updates the executable cooking process list again on the basis of the cooking status information. At this time, in a case where there is a plurality of same cooking processes, the information processing apparatus 10 extracts the cooking processes that can be unified by the extracting section 18, collects the amount of materials, and unifies the cooking processes. The information processing apparatus 10 causes the process to proceed to step S506 in a case where the process of step S505 ends.

The information processing apparatus 10 updates the cooking cost of the executable cooking process (step S506). For example, the information processing apparatus 10 calculates and sets/updates the cost of the cooking person CP for each cooking process on the basis of the profile of the cooking person data 130D. The information processing apparatus 10 causes the process to proceed to step S507 in a case where the process of step S506 ends.

The information processing apparatus 10 specifies the recommended cooking processes of the cooking person CP and the cooking robot 400 (step S507). For example, the information processing apparatus 10 specifies the cooking processes of the cooking processes executable or scheduled to be executed, which are recommended to be handled by the cooking person CP and the cooking robot 400 on the basis of the estimation result of the estimating section 19, the costs of the cooking person CP and the cooking robot 400, or the like. The information processing apparatus 10 terminates the processing procedure of FIG. 25 in a case where the process of step S507 ends. Then, the information processing apparatus 10 returns to the process of step S5 illustrated in FIG. 22.

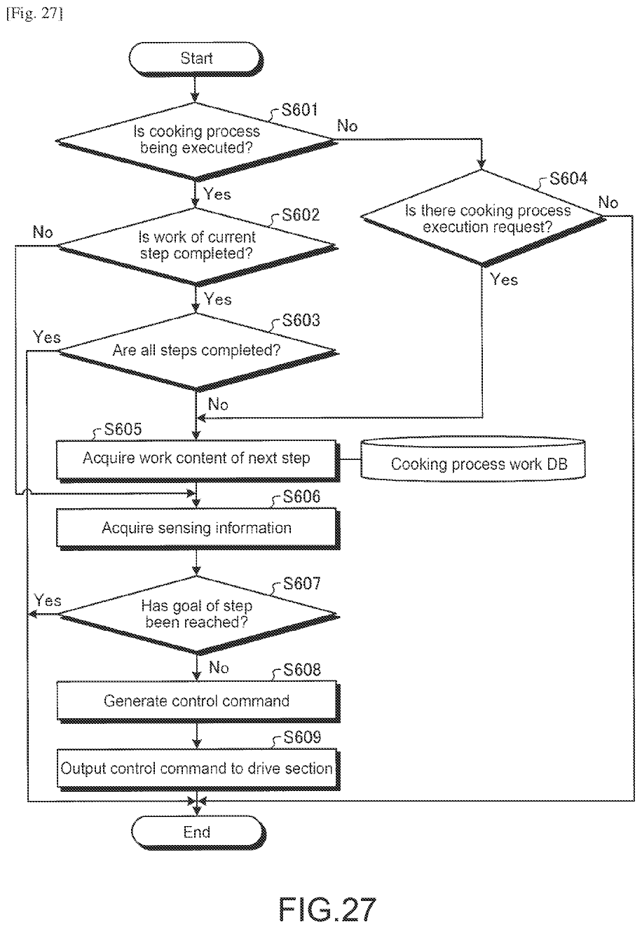

Returning to the processing procedure illustrated in FIG. 22, the information processing apparatus 10 executes a cooking robot control process (step S6). For example, the information processing apparatus 10 executes a processing procedure illustrated in FIG. 27 if the cooking robot control process is executed.

As illustrated in FIG. 27, the information processing apparatus 10 determines whether or not the cooking robot 400 is executing the cooking process (step S601). In a case where it is determined that cooking robot 400 is executing the cooking process (Yes in step S601), the information processing apparatus 10 causes the process to proceed to step S602.

The information processing apparatus 10 determines whether or not a task of the current step is completed (step S602). Note that, in the present disclosure, cooking is divided into units of cooking processes. Furthermore, the cooking process is divided into units of tasks executed by the cooking robot 400, and the unit of the task is referred to as a step. For example, in a case where food is “omelet”, the cooking process includes steps such as “breaking an egg” and “stilling”. Furthermore, for example, for a step of “breaking an egg”, the cooking process may include “detecting a position of an egg”, “detecting a position of a bowl”, “moving an arm to the position of the egg”, “holding the egg”, “moving the arm above the bowl”, “breaking the eggshell”, “checking that the egg enters in the bowl”, and the like. In other words, the step of the cooking process is a step that defines a detailed operation and conditions of the cooking robot 400, and is the basis of the operation of the cooking robot 400. Then, the information processing apparatus 10 determines whether or not the current step is completed on the basis of, for example, a control result of the cooking robot 400, the detection result of the detecting section 15, or the like. In a case where it is determined that the task of the current step is not completed (Yes in step S602), the information processing apparatus 10 causes the process to proceed to step S603.

The information processing apparatus 10 determines whether or not all steps of the cooking process have been completed (step S603). In a case where it is determined that all steps have been completed (Yes in step S603), the information processing apparatus 10 terminates the processing procedure in FIG. 27 and returns to the process in step S6 illustrated in FIG. 22. Further, in a case where it is determined that there is any one step which is not completed (No in step S603), the information processing apparatus 10 causes the process to proceed step S605. The information processing apparatus 10 acquires contents of the task of the next step (step S605). For example, the information processing apparatus 10 acquires the next step of the cooking process from the cooking process task database or the like. The information processing apparatus 10 causes the process to proceed to step S606 in a case where the process of step S605 is completed.

The information processing apparatus 10 acquires the sensing information from the sensing apparatus 300 via the communication section 14 (step S606). Then, the information processing apparatus 10 determines whether or not the goal of the step has been reached (step S607). For example, the information processing apparatus 10 determines that the goal of the step has been reached in a case where the sensing information indicates that the goal of the current step has been reached. Then, in a case where it is determined that the goal of the step has been reached (Yes in step S607), the information processing apparatus 10 terminates the processing procedure of FIG. 27 and the process returns to the process of step S6 illustrated in FIG. 22.

Further, in a case where it is determined that the goal of the step has not been reached (No in step S607), the information processing apparatus 10 causes the process to proceed to step S608. The information processing apparatus 10 generates a control command (step S608). For example, the information processing apparatus 10 generates the following control command on the basis of contents of the sensing information and the current status of a drive section or the like of the cooking robot 400. Then, the information processing apparatus 10 outputs the control command to the drive section (step S609). For example, the information processing apparatus 10 transmits the control command to the drive section of the cooking robot 400 via the communication section 14. As a result, the cooking robot 400 causes the drive section to be driven on the basis of the control command of the information processing apparatus 10. Then, the information processing apparatus 10 terminates the processing procedure of FIG. 27 and returns to the process of step S6 illustrated in FIG. 22.

Further, in a case where it is determined that the task of the current step is not completed (No in step S602), the information processing apparatus 10 causes the process to proceed to step S606 described above. Then, in a case where a series of processes from step S606 to step S609 is executed, the information processing apparatus 10 terminates the processing procedure of FIG. 27 and returns to the process of step S6 illustrated in FIG. 22.

In a case where it is determined that the cooking process is not being executed (No in step S601), the information processing apparatus 10 causes the process to proceed step S604. The information processing apparatus 10 determines whether or not there is a cooking process execution request (step S604). In a case where it is determined that there is a cooking process execution request (Yes in step S604), the information processing apparatus 10 causes the process to proceed to step S605 described above. Then, in a case where a series of processes from step S605 to step S609 is executed, the information processing apparatus 10 terminates the processing procedure of FIG. 27 and returns to the process of step S6 illustrated in FIG. 22. Further, in a case where it is determined that there is no cooking process execution request (No in step S604), the information processing apparatus 10 terminates the processing procedure of FIG. 27 and returns to the process of step S6 illustrated in FIG. 22.

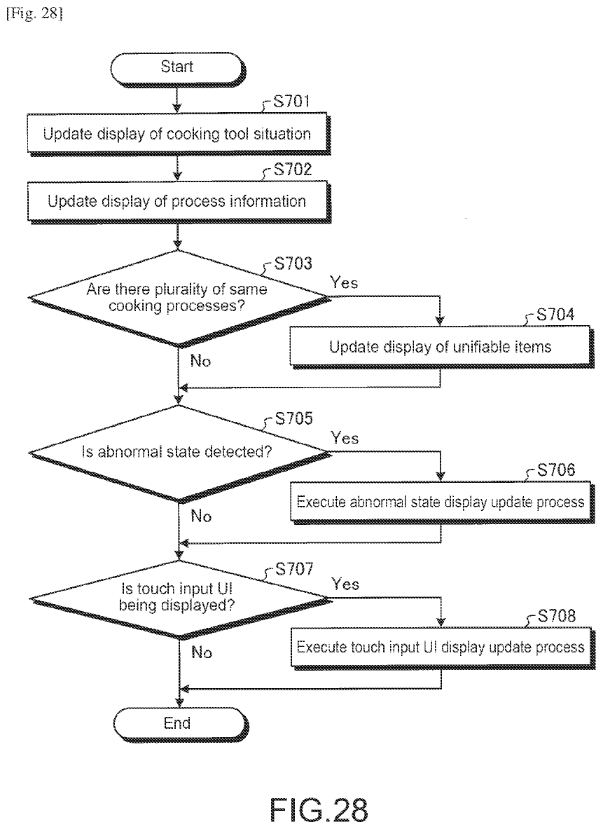

Referring back to the processing procedure illustrated in FIG. 22, the information processing apparatus 10 executes a touch panel display contents update process (step S7). For example, the information processing apparatus 10 executes a processing procedure illustrated in FIG. 28 in a case where the touch panel display contents update process is executed.

As illustrated in FIG. 28, the information processing apparatus 10 updates display of a cooking tool situation (step S701). For example, the information processing apparatus 10 causes the touch panel 200 to update the display related to the cooking tool on the screen G on the basis of a recognition result of step S4 or the like. Then, the information processing apparatus 10 updates the display of the process information (step S702). For example, the information processing apparatus 10 causes the touch panel 200 to update the display of the process information 110 or the like related to the cooking process on the screen G in accordance with the recognition result of step S5 or the like. Then, if the process of step S702 ends, the information processing apparatus 10 causes the process to proceed to step S703.

The information processing apparatus 10 determines whether or not there is a plurality of same cooking processes (step S703). For example, if a cooking process to be unified is included in the recognition result of step S5, the information processing apparatus 10 determines that there is a plurality of same cooking processes. In a case where it is determined that there is a plurality of same cooking processes (Yes in step S703), the information processing apparatus 10 causes the process to proceed step S704. The information processing apparatus 10 updates display of unifiable items (step S704). For example, the touch panel 200 is caused to update the display of the unification information 111 or the like on the screen G indicated by the recognition result of step S5. Then, if the process of step S702 ends, the information processing apparatus 10 causes the process to proceed to step S705. Further, in a case where it is determined that a plurality of same cooking processes is not present (No in step S703), the information processing apparatus 10 causes the process to proceed step S705.

The information processing apparatus 10 determines whether or not an abnormal state is detected (step S705). For example, the information processing apparatus 10 determines that an abnormal state is detected in a case where the detection of the occurrence of an abnormality is included in the recognition result of step S5. In a case where it is determined that an abnormal state is detected (Yes in step S705), the information processing apparatus 10 causes the process to proceed to step S706. The information processing apparatus 10 executes an abnormal state display update process (step S706). For example, the information processing apparatus 10 executes the abnormal state display update process and causes the touch panel 200 to change the process information 100 of the corresponding screen G to have a display form indicating an abnormality. Then, if the process of step S706 ends, the information processing apparatus 10 causes the process to proceed to step S707. Further, in a case where it is determined that the abnormal state is not detected (No in step S705), the information processing apparatus 10 causes the process to proceed to step S707.

The information processing apparatus 10 determines whether or not a touch input user interface (UI) is being displayed. The touch input UI includes, for example, a UI for performing an operation for inputting a food name and adding/cancelling food. For example, in a case where the touch input UI is being displayed on the touch panel 200, the information processing apparatus 10 determines that the touch input UI is being displayed. In a case where it is determined that the touch input UI is being displayed (Yes in step S707), the information processing apparatus 10 causes the process to proceed to step S708. The information processing apparatus 10 executes a touch input UI display update process (step S708). For example, the information processing apparatus 10 executes the touch input UI display update process and causes the touch panel 200 to update the display of the screen G on the basis of the input result of the touch input UI. Then, in a case where the process of step S707 ends, the information processing apparatus 10 terminates the processing procedure of FIG. 28 and returns to the process of step S7 illustrated in FIG. 22. In a case where it is determined that the touch input UI is not being displayed (No in step S707), the information processing apparatus 10 terminates the processing procedure of FIG. 28 and returns to the process of step S7 illustrated in FIG. 22.

Returning to the processing procedure illustrated in FIG. 22, the information processing apparatus 10 determines whether or not the cooking ends (step S8). For example, the information processing apparatus 10 determines that the cooking ends, for example, in a case where the food displayed on the screen G disappears or in a case where an end request is received. In a case where it is determined that the cooking does not end (No in step S8), the information processing apparatus 10 returns the process to step S1 described above. Further, in a case where it is determined that the cooking ends (Yes in step S8), the information processing apparatus 10 terminates the processing procedure in FIG. 22.

In an embodiment of the present disclosure, the information processing apparatus 10 performs the display control of the touch panel 200 by executing the processing procedure of FIG. 22. In other words, the information processing apparatus 10 executes the processing procedure of FIG. 22 and functions as the display control section 11, the specifying section 12, detecting section 15, the usage situation detecting section 16, the determining section 17, the extracting section 18, and the estimating section 19.

As described above, the information processing apparatus 10 according to an embodiment of the present disclosure causes the touch panel 200 (the display apparatus) to display the screen G including a plurality of pieces of process information 110 for cooking food. In a case where the cooking robot 400 specifies the cooking process of a plurality of cooking processes, the information processing apparatus 10 causes the touch panel 200 to display the process information 110 indicating the cooking process in association with the robot information 150. Accordingly, in a case where all of a plurality of food cooking processes are displayed on the screen G, the information processing apparatus 10 can cause the cooking person CP to recognize the cooking process to be performed by the cooking robot 400. As a result, the information processing apparatus 10 can support the cooking person CP and the cooking robot 400 to perform cooking cooperatively and efficiently.

Further, the information processing apparatus 10 changes the display form of the process information 110 on the screen G on the basis of the detection result of detecting the progress of the food. Accordingly, in a case where all of a plurality of food cooking processes are displayed on the screen G, the information processing apparatus 10 can cause the progress of the food to be displayed with the change in the display form of the process information 110. As a result, the information processing apparatus 10 can further improve the efficiency by causing the cooking person CP to comprehend a relation between the progress of cooking and the cooking process to be performed by the cooking robot 400.

Further, the information processing apparatus 10 includes, in the process information 110, the task information indicating the task in the cooking process and the material information indicating the material used in the task. As a result, the information processing apparatus 10 can display the process information 110 on the screen G and indicate, to the cooking person CP, the task and the material to be used for each cooking process. Further, the information processing apparatus 10 can cause the task contents of the cooking process executed by the cooking robot 400 in accordance with the process information 110 and the robot information 150 to be recognized. As a result, the information processing apparatus 10 can perform efficient support by causing the cooking person CP to recognize so that it is possible to select the cooking process to perform after causing the task in the cooking process of the cooking robot 400 to be recognized.

Further, in a case where the cooking tool is used in the cooking process, the information processing apparatus 10 displays the tool information 120 indicating the cooking tool in association with the process information 110 of the screen G. As a result, the information processing apparatus 10 can cause the cooking person CP to recognize the cooking tool used in the cooking process by causing the process information 110 of the screen G to be displayed in association with the tool information 120. As a result, the information processing apparatus 10 causes the cooking person CP to refer to the cooking process and the cooking tool used in the cooking process, so that it is possible to support the cooking person CP to select an efficient cooking process.

Further, the information processing apparatus 10 updates the tool information 120 of the screen G to indicate the detected usage situation of the cooking tool. Accordingly, the information processing apparatus 10 causes the cooking person CP to recognize the usage situation of the cooking tool used in the cooking process by changing the tool information 120 associated with the process information 110 in accordance with the usage situation of the cooking tool. As a result, the information processing apparatus 10 causes the cooking person CP to recognize the usage situation of the cooking tool, so that it is possible to induce the cooking person CP to an efficient cooking process corresponding to the usage situation of the cooking tool.

Further, in a case where the cooking appliance is used in the cooking process, the information processing apparatus 10 causes the appliance information 130 indicating the cooking appliance to be displayed in association with the process information 110 of the screen G. Accordingly, the information processing apparatus 10 can cause the cooking person CP to recognize the cooking appliance used in the cooking process by causing the process information 110 of the screen G to be displayed in association with the appliance information 130. As a result, the information processing apparatus 10 causes the cooking person CP to refer to the cooking process and the cooking appliance used in the cooking process, so that it is possible to support the cooking person CP to select the efficient cooking process.

Further, the information processing apparatus 10 updates the appliance information 130 of the screen G to indicate the detected usage situation of the used tool. Accordingly, the information processing apparatus 10 can cause the cooking person CP to recognize the usage situation of the cooking appliance used in the cooking process by changing the appliance information 130 associated with the process information 110 in accordance with the usage situation of the cooking appliance. As a result, the information processing apparatus 10 causes the cooking person CP to recognize the usage situation of the cooking appliance, so that it is possible to induce the cooking person CP to an efficient cooking process according to the usage situation of the cooking appliance.

Further, in a case where the screen G displays the process information 110 for every two or more foods, the information processing apparatus 10 extracts the process information 110 of a plurality of pieces of process information 110 to be displayed on the screen G, which can be unified. The information processing apparatus 10 causes the unification information 111 indicating the cooking process which can be unified to be displayed on the screen G on the basis of the extracted process information 110 (the cooking process) in association with the process information 110. Accordingly, the information processing apparatus 10 can cause the cooking person CP to recognize that the cooking processes of a plurality of foods are unified. As a result, the information processing apparatus 10 can improve the efficiency of cooking a plurality of foods in parallel.

Further, if the cooking process indicated by the unification information 111 ends, the information processing apparatus 10 changes the display form of the process information 110 of the screen G indicating the unified cooking process. Accordingly, even the cooking processes of a plurality of foods are unified, the information processing apparatus 10 can cause the cooking person CP to recognize that the task in the unified process has been completed by the change in the display form of the process information. As a result, the information processing apparatus 10 can further improve the efficiency of cooking a plurality of foods in parallel.

Further, in a case where the cooking process in which the cooking person CP performs cooking, the information processing apparatus 10 causes the process information 110 indicating the cooking process to be displayed on the screen G in association with the cooking person information 140. Accordingly, in a case where all of a plurality of food cooking processes are displayed on the screen G, the information processing apparatus 10 can cause the other cooking persons CP to recognize the cooking process to be performed by the cooking person CP by the cooking person information 140. As a result, the information processing apparatus 10 can support a plurality of cooking persons CP and the cooking robot 400 to perform cooking cooperatively and efficiently.

Further, the information processing apparatus 10 estimates the cooking process of a plurality of food cooking processes, which the cooking robot 400 is not good at, and causes the process information 110 indicating the cooking process to be displayed in association with second information indicating that cooking robot 400 is not good at it. Accordingly, the information processing apparatus 10 can cause the cooking person CP to recognize the cooking process which the cooking robot 400 is not good at. As a result, the information processing apparatus 10 can cause the cooking person CP to perform the cooking process which the cooking robot 400 is not good, and thus it is possible to improve the efficiency of cooking.

In an embodiment of the present disclosure, the information processing apparatus 10 causes the information indicating that the cooking person CP is recommended to be displayed in association with the cooking person information 140 as the second information, but the present disclosure is not limited thereto. For example, the information processing apparatus 10 may use an icon or the like indicating that the cooking robot 400 is not good at it as the second information. Further, for example, the information processing apparatus 10 may be configured to cause the process information 110 indicating the cooking process which the cooking robot 400 is not good at in a different display form.

Further, if the occurrence of an abnormality in the cooking process is detected, the information processing apparatus 10 causes the process information 110 of the cooking process to be abnormally displayed. Accordingly, the information processing apparatus 10 causes the cooking person CP to recognize the abnormality occurred in the cooking process by the process information 110 of the screen G. As a result, the information processing apparatus 10 can recover the delay of cooking or the like by eliminating an abnormality in the cooking process by the cooking person CP.

Further, in a case where the cooking process in which recooking is performed, the information processing apparatus 10 changes the display form of the process information 110 of the cooking process. Accordingly, the information processing apparatus 10 causes the other cooking persons CP to recognize the cooking process in which recooking has occurred by the process information of the screen G. As a result, the information processing apparatus 10 can support a plurality of cooking persons CP and the cooking robot 400 to perform cooking cooperatively and efficiently.

Further, the information processing apparatus 10 changes the display form of the process information 110 of the screen G on the basis of the cooking person data 130D indicating at least one of cooking at which the cooking person CP is not good or a prohibited matter. Accordingly, the information processing apparatus 10 can cause the cooking person CP who is not allowed to perform the cooking process on the basis of the display form of the process information 110 of the screen G. As a result, the information processing apparatus 10 can make cooking more efficient by causing the cooking person CP or the cooking robot 400 suitable for the cooking process to perform it.

In the above embodiments, the example in which the information processing apparatus 10 adds food to the screen G one by one at a time has been described, but the present disclosure is not limited thereto. For example, the information processing apparatus 10 may accept a plurality of different foods simultaneously. For example, in a case where three foods are accepted, the information processing apparatus 10 causes three display areas 13A corresponding to the three foods to be displayed on the screen G of the touch panel 200. Then, the information processing apparatus 10 causes the process information of executable cooking process of a plurality of cooking processes of the three foods in a display form different from the other process information.

The information processing apparatus 10 of the above embodiments may cause the touch panel 200 to display an operation screen for copying or deleting the food in the display area 13A in a case where a predetermined operation on the food name of the display area 13A of the screen G is detected. As a result, since information processing apparatus 10 can easily copy or delete the food displayed on the screen G, and thus the operability can be improved.

### MODIFIED EXAMPLE (1) OF EMBODIMENTS

For example, the example in which the information processing apparatus 10 according to an embodiment of the present disclosure displays the screen G toward a plurality of cooking persons CP has been described, but the screen G can be displayed toward a specific cooking person CP.

For example, in a case where the task of the cooking process is completed, the cooking person CP refers to the screen G of the touch panel 200 to select the next cooking process. For this reason, the information processing apparatus 10 determines whether or not the cooking person CP is viewing the screen G the determining section 17. Then, the information processing apparatus 10 changes the display contents of the screen G on the basis of the cooking person CP determined to be viewing by the determining section 17. For example, in a case where the cooking person CP viewing the screen G is recognized in a state in which the other cooking persons CP are not viewing, the information processing apparatus 10 acquires, for example, information indicating cooking at which the cooking person CP is good or bad, a cooking ability, or the like on the basis of the cooking person data 130D of the cooking person CP. Then, the information processing apparatus 10 changes the size, the length, or the like of the process information 110 corresponding to the ability of the cooking person CP.

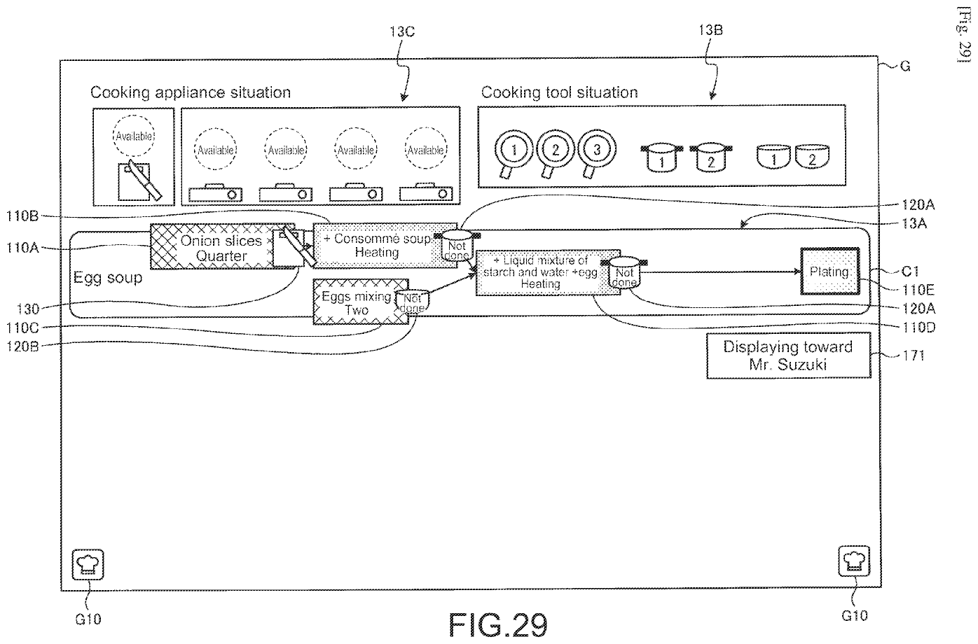

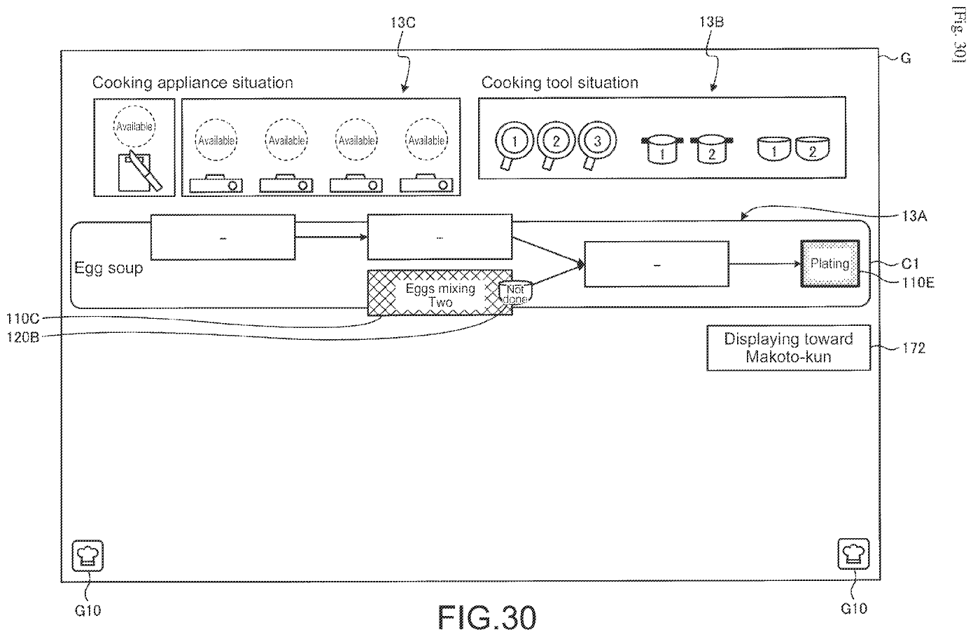

FIGS. 29 and 30 are diagrams illustrating an example of the screen of the information processing apparatus 10 according to a modified example of an embodiment of the present disclosure. In a situation illustrated in FIG. 29, the information processing apparatus 10 recognizes that the recognized cooking person CP is “Mr. Suzuki”, and the ability to mix eggs is excellent. The information processing apparatus 10 causes the touch panel 200 to display the screen G toward the cooking person CP.

The screen G illustrated in FIG. 29 includes a display area 13A in which the cooking process data 130A is displayed in a case where cooking of the food C1 is supported. For example, the food C1 is an egg soup. On the screen G, the process information 110A, 110B, 110C, 110D, and 110E of the cooking process data 130A of the food C1 is displayed in the display area 13A. On the screen G, screen information 171 indicating that the screen G is directed to the cooking person CP is displayed below the display area 13A. In the example illustrated in FIG. 29, the screen information 171 includes information indicating “displaying toward Mr. Suzuki”.

The information processing apparatus 10 makes the length of the process information 1100 indicating the cooking process to mix eggs shorter than the length of other the process information 110 as the screen G toward the cooking person CP with excellent ability to mix eggs. In other words, the information processing apparatus 10 indicates that the cooking time can be shortened when the cooking person CP performs the cooking process indicated by the executable process information 110C by changing the display size of the process information 110C. Further, the information processing apparatus 10 may cause the cooking person CP not to perform it by increasing the size or the length of the process information 110 indicating the cooking process at which the cooking person CP is not good.

In a situation illustrated in FIG. 30, the information processing apparatus 10 recognizes that the recognized cooking person CP is “Makoto-kun” who is a kid. The information processing apparatus 10 causes the touch panel 200 to display the screen G toward the cooking person CP who is a kid.

The screen G illustrated in FIG. 30 includes a display area 13A in which the cooking process data 130A is displayed in a case where cooking of the food C1 is supported. For example, the food C1 is an egg soup. The screen G is displayed so that only the process information 110B and the process information 110E of the process information 110A, 110B, 110C, 110D, and 110E included in the cooking process data 130A of the food C1, in which cooking by a kid is executable, are recognizable in the display area 13A. In the example illustrated in FIG. 30, the screen C masks the process information 110 other than the process information 110B and the process information 110E. On the screen G, screen information 172 indicating that the screen G is directed to the cooking person CP who is a kid is displayed below the display area 13A. In the example illustrated in FIG. 30, the screen information 172 includes information indicating “displaying toward Makoto-kun”.

As described above, the information processing apparatus 10 changes the display contents of the screen G on the basis of the cooking person CP viewing the screen G. Accordingly, the information processing apparatus 10 can induce the cooking person CP to the cooking process indicated by the process information 110 by causing the process information 110 to be displayed on the screen G, the process information 110 indicating the cooking process wished to cause the cooking person CP viewing the screen G to perform. As a result, the information processing apparatus 10 can improve the efficiency of cooking by causing the cooking person CP suitable for the cooking process to perform it.

### <Display Example of Touch Input UI of Embodiments>

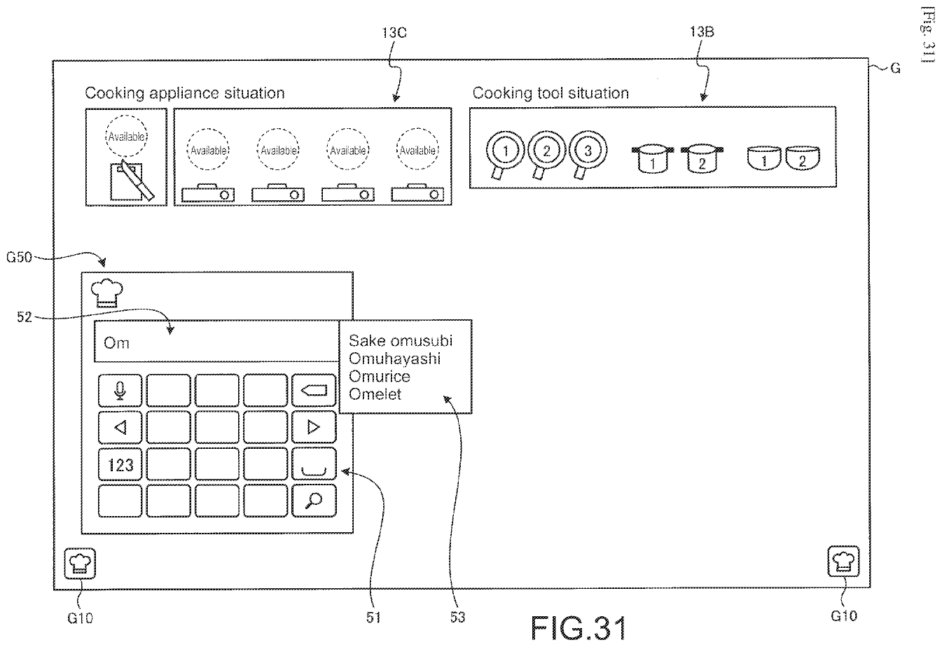

FIG. 31 is a diagram illustrating an example of the screen G displaying the touch input UI of an embodiment of the present disclosure. As illustrated in FIG. 31, the information processing apparatus 10 causes the touch panel 200 to display an input screen G50 indicating the touch input UI on the screen G by the display control section 11. For example, in a case where there is no food to be displayed on the screen G, the information processing apparatus 10 causes the input screen G50 to be displayed on the touch panel 200 at a timing at which a display request is received from the cooking person CP or the like in accordance with selection of the icon G10 on the screen G. The input screen G50 includes a key area 51 and a state notification area 52. The key area 51 is an area for displaying various types of keys to be input. The state notification area 52 is an area for displaying characters selected as input candidates. in the example illustrated in FIG. 31, the state notification area 52 of the screen G indicates that a Japanese hiragana “omu” is selected. In this case, the information processing apparatus 10 searches for food including the character string of the input candidate “Om” from the cooking process data 130A, the database, and the like. Then, the information processing apparatus 10 extracts food names of “sake omusubi”, “Omuhayashi”, “Omurice”, and “Omelet” as search results. The information processing apparatus 10 displays the search results in a selection area 53.

If the result indicating the name of the food or the like selected in the selection area 53 of the input screen G50 is acquired from the touch panel 200, the information processing apparatus 10 acquires the cooking process data 130A of the food corresponding to the name of the food of the result. Then, the information processing apparatus 10 causes the process information 110 of the cooking process data 130A to be displayed in the display area 13A of the food of the screen G.

As described above, the information processing apparatus 10 causes the input screen G50 which is the input screen to be displayed further towards a top of the screen G, and causes the process information corresponding to the food of the name of the input food to be displayed on the screen G. Accordingly, the information processing apparatus 10 can cause the process information 110 of the food to be displayed on the screen G by receiving the food name in the input screen. As a result, in the information processing apparatus 10, complicated operations are unnecessary, and thus the convenience of the cooking person CP can be improved. Further, the information processing apparatus 10 may cause the food name to be input by a voice of the cooking person CP. For example, the information processing apparatus 10 may acquire the voice data of the cooking person CP from the sensing apparatus 300 or the like via the communication section 14 and extract the food name from the character string obtained by converting the voice data. In this case, the information processing apparatus 10 can use, for example, an automatic speech recognition process.

### Modified Example (2) of Embodiments

In the above embodiments, if the food displayed on the screen G is canceled, and the cooking process in which the cooking has been started in the food is allocable to other foods, the display control section 11 of the information processing apparatus 10 may cause the process information 110 indicating the cooking process and the process information of the other foods to be displayed on the screen 6 in association with each other.

For example, the information processing apparatus 10 searches for the cooking processes from the allocable cooking processes of the other foods in a case where the cooking process in which the cooking person CP has already started cooking is canceled. Then, the information processing apparatus 10 allocates the canceled cooking process to the allocable cooking processes of the other foods. Further, the information processing apparatus 10 deletes the canceled cooking processes or temporarily puts them on hold in a case where there are no cooking processes of other foods to which the cooking processes can be allocated. In a case where the canceled. cooking process is put on hold, the information processing apparatus 10 may allocate it to the allocable cooking process of the subsequent food.

As described above, if the cooking process in which the cooking has been started in the canceled food can be allocated to other foods, the information processing apparatus 10 causes the process information 110 indicating the cooking process and the process information 110 of the other foods to be displayed on the screen G in association with each other. Accordingly, the information processing apparatus 10 can cause the cooking person CP to recognize that the cooking process in which the cooking has been started can be allocated to other foods. As a result, the information processing apparatus 10 can support effective use of the cooking process in which the cooking has been started in a case where the food is canceled.

### <Configuration Example of Cooking Robot According to Embodiments>

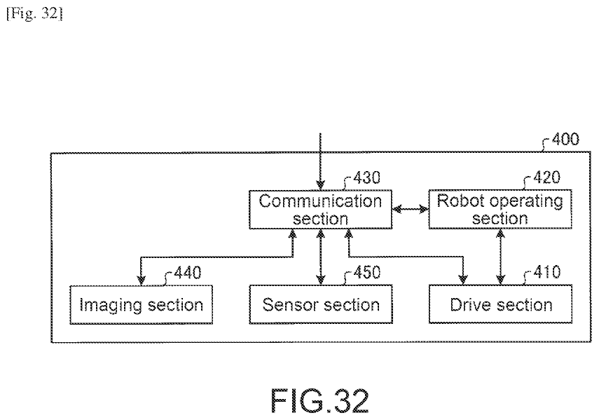

FIG. 32 is a diagram illustrating a configuration example of the cooking robot 400 according to an embodiment of the present disclosure. As illustrated in FIG. 32, the cooking robot 400 includes a drive section 410, a robot operating section 420, a communication section 430, an imaging section 440, and a sensor section 450. The drive section 410 causes respective drivable parts of the cooking robot 400 to be driven. The robot operating section 420 controls the drive section 410. The robot operating section 420 controls the drive section 410 in accordance with an operation command or the like from the information processing apparatus 10. The robot operating section 420 controls the drive of the drive section 410 on the basis of the detection result of the imaging section 440, the sensor section 450, or the like. The communication section 430 communicates with the information processing apparatus 10 via a network. The imaging section 440 outputs an image obtained by capturing the actual periphery of the cooking robot 400 to the robot operating section 420, the information processing apparatus 10, and the like. The sensor section 450 outputs information indicating the detected result to the robot operating section 420, the information processing apparatus 10, and the like. Note that, in an embodiment of the present disclosure, the example in which the information processing apparatus 10 outputs the command to the cooking robot from the outside of the cooking robot 400 to operate the cooking robot 400, but the present disclosure is not limited thereto. For example, the information processing apparatus 10 may be installed in the cooking robot 400.

### <Hardware Configuration>

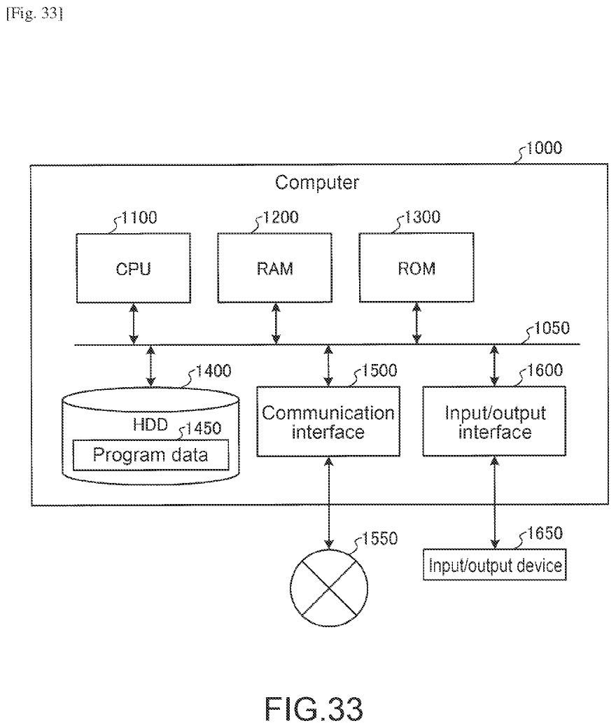

The information processing apparatus 10 according to an embodiment of the present disclosure described above is realized by, for example, a computer 1000 configured as illustrated in FIG. 33. The information processing apparatus 10 according to an embodiment of the present disclosure will be described below as an example. FIG. 33 is a hardware configuration diagram illustrating an example of the computer 1000 for realizing the function of the information processing apparatus 10. The computer 1000 includes a CPU 1100, a RAM 1200, a read only memory (ROM) 1300, a hard disk drive (HDD) 1400, a communication interface 1500, and an input/output interface 1600. The components of the computer 1000 are connected by a bus 1050.

The CPU 1100 operates on the basis of a program stored in the ROM 1300 or the HDD 1400 and controls the respective sections. For example, the CPU 1100 develops the program stored in the ROM 1300 or the HDD 1400 onto the RAM 1200, and executes processes corresponding to various types of programs.

The ROM 1300 stores a boot program such as a basic input output system (BIOS) executed by the CPU 1100 in a case where the computer 1000 starts up, a program depending on hardware of the computer 1000, and the like.

The HDD 1400 is a computer-readable recording medium which non-temporarily records a program executed by the CPU 1100 and data used by the program. Specifically, the HDD 1400 is a recording medium for recording an information processing program according to an aspect of the present disclosure which is an example of program data 1450.

The communication interface 1500 is an interface for connecting the computer 1000 to an external network 1550 (for example, the Internet). For example, the CPU 1100 receives data from other devices via the communication interface 1500, and transmits data generated by the CPU 1100 to other devices.

The input/output interface 1600 is an interface for connecting the input/output device 1650 and the computer 1000. For example, the CPU 1100 receives data from input devices such as a keyboard and a mouse via the input/output interface 1600. Further, the CPU 1100 transmits data to output devices such as a display, a speaker, or a printer via the input/output interface 1600. Further, the input/output interface 1600 may function as a media interface for reading a program or the like recorded in a predetermined recording medium (medium). Examples of the medium include an optical recording medium such as a digital versatile disc (DVD), a magneto-optical recording medium such as a magneto-optical disk (MO), a tape medium, a magnetic recording medium, and a semiconductor memory.

For example, in a case where the computer 1000 functions as the information processing apparatus 10 according to an embodiment of the present disclosure, the CPU 1100 of the computer 1000 executes the program loaded onto the RAM 1200 and implements the functions of the display control section 11, the specifying section 12, the detecting section 15, the usage situation detecting section 16, the determining section 17, the extracting section 18, the estimating section 19, and the like. Further, the HDD 1400 stores an information processing program according to an aspect of the present disclosure and data in the storage section 13. Note that the CPU 1100 reads the program data 1450 from the HDD 1400 and executes it, but as another example, the program may be acquired from other apparatuses via the external network 1550.

Embodiments of the present disclosure have been described in detail with reference to the appended drawings, but the technical scope of the present disclosure is not limited to such an example. It is obvious that those skilled in the technical field of the present disclosure can conceive of various types of changes or modifications within the scope of the technical spirit described in claims, and, of course, it is understood that they belong to the technical scope of the present disclosure.

Further, the effects described in this specification are merely explanatory or illustrative and not limiting. That is, the technology according to the present disclosure can exhibit other effects apparent to those skilled in the art from the description of this specification in addition to or instead of the effects described above.

Further, it is possible to generate a program causing hardware such as the CPU, the ROM, and the RAM installed in the computer to perform the same functions as those of the configuration of the information processing apparatus 10 and to also provide a computer readable recording medium having the program recorded therein.

Further, respective steps of the process in the information processing apparatus 10 in this specification need not necessarily be processed chronologically in accordance with the order described in the flowcharts. For example, respective steps in the process of the information processing apparatus 10 may be processed in an order different from the order described in the flowcharts or may be processed in parallel.

Note that the present technology can also have the following configurations.

(1) An information processing apparatus, including:
a specifying section that specifies a cooking process of a plurality of cooking processes for cooking food, the cooking process being to be performed by a robot; and
a display control section that causes a display section to display process information indicating each of the plurality of cooking processes while associating robot information indicating the robot with the process information indicating the cooking process specified by the specifying section.

(2) The information processing apparatus according to (1), further including a detecting section that detects progress of the food, in which
the display control section changes a display form of the process information on the basis of a detection result of the detecting section.

(3) The information processing apparatus according to any one of (1) or (2), in which
the process information includes task information indicating a task in the cooking process and material information indicating a material used in the task.

(4) The information processing apparatus according to any one of (1) to (3), in which,
in a case where a cooking tool is used in the cooking process, the display control section causes the display section to display tool information indicating the cooking tool in association with the process information.

(5) The information processing apparatus according to any one of (1) to (4), further including a usage situation detection section that detects a usage situation of the cooking tool indicated by the tool information, in which
the display control section changes the tool information to indicate the usage situation of the cooking tool detected by the usage situation detecting section.

(6) The information processing apparatus according to any one of (1) to (5), in which,
in a case where a cooking appliance is used in the cooking process, the display control section causes the display section to display appliance information indicating the cooking appliance in association with the process information.

(7) The information processing apparatus according to any one of (1) to (6), further including a usage situation detection section that detects a usage situation of the cooking appliance indicated by the appliance information, in which
the display control section changes the appliance information to indicate the usage situation of the cooking appliance detected by the usage situation detecting section.

(8) The information processing apparatus according to any one of (1) to (7), further including an extracting section that extracts unifiable process information of the plurality of pieces of process information displayed on the display section in a case where the display section displays the process information for each of the plurality of foods, in which
the display control section causes the display section to display unification information indicating a unifiable cooking process on the basis of the process information extracted by the extracting section in association with the process information.

(9) The information processing apparatus according to any one of (1) to (8), in which the display control section changes a display form of the process information indicating the unified cooking process if the cooking process indicated by the unification information ends.

(10) The information processing apparatus according to any one of (1) to (9), in which
the detecting section detects the cooking process in which a cooking person performs cooking, and
the display control section causes the display section to display the process information indicating the cooking process detected by the detecting section in association with cooking person information indicating the cooking person.

(11) The information processing apparatus according to any one of (1) to (10), further including an estimating section that estimates the cooking process of the plurality of cooking processes of the food, which the robot is not good at, in which
the display control section causes the process information indicating the cooking process estimated by the estimating section to be associated with second information indicating that the robot is not good at.

(12) The information processing apparatus according to any one of (1) to (11) in which
the detecting section detects an occurrence of an abnormality in the cooking process, and
the display control section causes the process information of the cooking process detected by the detecting section to be abnormally displayed.

(13) The information processing apparatus according to any one of (1) to (12) in which
the detecting section detects the cooking process in which the cooking is performed again, and
the display control section changes the display form of the process information on the basis of the cooking process in which the cooking is performed again, the cooking process being detected by the detecting section.

(14) The information processing apparatus according to any one of (1) to (13), in which the display control section changes the display form of the process information on the basis of cooking person data indicating at least one of cooking at which the cooking person is not good or a prohibited matter.

(15) The information processing apparatus according to any one of (1) to (14), further including a determining section that determines whether or not the cooking person is viewing the display section, in which
the display control section changes display contents of the display section on the basis of the cooking person determined to be viewing by the determining section.

(16) The information processing apparatus according to any one of (1) to (15), in which the display control section causes the display section to display an input screen for inputting a name of the food, and causes the display section to display the process information corresponding to the food of the input name.

(17) The information processing apparatus according to any one of (1) to (16), in which, if the food displayed in the display section is canceled, and the cooking process in which cooking has been started in the food is allocable to other foods, the display control section causes the process information indicating the cooking process and the process information of the other foods to be displayed on the display section in association with each other.

(18) An information processing method, including:
specifying, by a computer, a cooking process of a plurality of cooking processes for cooking food, the cooking process being to be performed by a robot; and
causing, by the computer, a display section to display process information indicating each of the plurality of cooking processes while associating robot information indicating the robot with the process information indicating the specified cooking process.

(19) A program causing a computer to function as:
a specifying section that specifies a cooking process of a plurality of cooking processes for cooking food, the cooking process being to be performed by a robot; and
a display control section that causes a display section to display process information indicating each of the plurality of cooking processes while associating robot information indicating the robot with the process information indicating the cooking process specified by the specifying section.

(20) An information processing apparatus including: circuitry configured to:
initiate display of information associated with a plurality of cooking processes for cooking a food item and robot information indicating one cooking process of the plurality of cooking processes to be performed by a robot.

(21) The information processing apparatus according to (20), wherein the circuitry is further configured to:
initiate display of cooking person information indicating another cooking process of the plurality of cooking processes to be performed by a cooking person.

(22) The information processing apparatus according to (20) or (21), wherein the circuitry is further configured to:
select between the robot and the cooking person to perform the plurality of cooking processes, based on the information associated with the plurality of cooking processes.

(23) The information processing apparatus according to any one of (20) to (22), wherein the circuitry is further configured to:
select between the robot information and the cooking person information as information to be displayed in association with the plurality of cooking processes, based on a result of the selection between the robot and the cooking person to perform the plurality of cooking processes.

(24) The information processing apparatus according to any one of (20) to (23), wherein the circuitry is further configured to:
select between the robot and the cooking person to perform the plurality of cooking processes, based further on robot data of the robot and cooking person data of the cooking person.

(25) The information processing apparatus according to any one of (20) to (24), wherein the cooking person data includes a feature or face of the cooking person to identify the cooking person.

(26) The information processing apparatus according to any one of (20) to (25), wherein the cooking person data includes information indicating an age of the cooking person.

(27) The information processing apparatus according to any one of (20) to (26), wherein the robot data includes information identifying the robot.

(28) The information processing apparatus according to any one of (20) to (27), wherein the robot data includes costs of the robot at performing the plurality of cooking processes and the cooking person data includes costs of the cooking person at performing the plurality of cooking processes.

(29) The information processing apparatus according to any one of (20) to (28), wherein the circuitry is further configured to:
compare the costs of the robot at performing the plurality of cooking processes and the costs of the cooking person at performing the plurality of cooking processes; and
select between the robot and the cooking person to perform the plurality of cooking processes, based further on a result of the comparison.

(30) The information processing apparatus according to any one of (20) to (29), wherein the circuitry is further configured to:
determine the costs of the robot at performing the plurality of cooking processes, based on proficiency levels of the robot at performing the tasks of the plurality of cooking processes; and
determine the costs of the cooking person at performing the plurality of cooking processes, based on proficiency levels of the cooking person at performing the tasks of the plurality of cooking processes.

(31) The information processing apparatus according to any one of (20) to (30), wherein the information associated with the plurality of cooking processes include task information indicating tasks of the plurality of cooking processes and material information indicating a quantity of materials used in the tasks.

(32) The information processing apparatus according to any one of (20) to (31), wherein the circuitry is further configured to:
determine a cost of the robot at performing one task of the one cooking process to be a first cost when a proficiency level of the robot at performing the one task is a first level and
determine a cost of the cooking person at performing the one task of the one cooking process to be a second cost higher than the first cost when a proficiency level of the cooking person at performing the one task is a second level lower than the first level.

(33) The information processing apparatus according to any one of (20) to (32), wherein the circuitry is further configured to:
compare the cost of the robot at performing the one task and the cost of the cooking person at performing the one task;
determine the cost of the cooking person at performing the one task to be lower than the cost of the robot at performing the one task, based on a result of the comparison; and
select the robot to perform the one cooking process, based on a result of the determination.

(34) The information processing apparatus according to any one of (20) to (33), wherein the information associated with the plurality of cooking processes for cooking the food item are displayed in an order of execution of the information associated with the plurality of cooking processes.

(35) The information processing apparatus according to any one of (20) to (34), wherein the circuitry is further configured to:
initiate display of cooking tool information in association with the plurality of cooking processes indicating a cooking tool used in the plurality of cooking processes and cooking appliance information in association with the plurality of cooking processes indicating a cooking appliance used in the plurality of cooking processes.

(36) The information processing apparatus according to any one of (20) to (35), wherein the circuitry is further configured to:
initiate display of cooking tool data including an icon indicating the cooking tool and cooking tool usage information indicating a usage situation of the cooking tool, and cooking appliance data including an icon indicating the cooking appliance and cooking appliance usage information indicating a usage situation of the cooking appliance.

(37) The information processing apparatus according to any one of (20) to (36), wherein the circuitry is further configured to:
change the cooking tool information and cooking tool usage information to indicate the usage situation of the cooking tool detected based on a detected usage situation of the cooking tool; and
change the cooking appliance information and cooking appliance usage information to indicate the usage situation of the cooking appliance detected based on a detected usage situation of the cooking appliance.

(38) An information processing method including:
displaying information associated with a plurality of cooking processes for cooking a food item and robot information indicating one cooking process of the plurality of cooking processes to be performed by a robot.

(39) A non-transitory computer-readable medium having embodied thereon a program, which when executed by a computer causes the computer to execute an information processing method, the method including:
displaying information associated with a plurality of cooking processes for cooking a food item and robot information indicating one cooking process of the plurality of cooking processes to be performed by a robot.

### REFERENCE SIGNS LIST

1 Cooking support system
10 Information processing apparatus
11 Display control section
12 Specifying section
13 Storage section
14 Communication section
15 Detecting section
16 Usage situation detecting section
17 Determining section
18 Extracting section
19 Estimating section
110 Process information
120 Tool information
130 Appliance information
140 Cooking person information
150 Robot information
130A Cooking process data
130B Cooking tool data
130C Cooking appliance data
130D Cooking person data
130E Robot data
200 Touch panel
300 Sensing apparatus
400 Cooking robot
500 Food order terminal
600 Information processing server
G Screen

1. An information processing apparatus comprising:
circuitry configured to:
initiate display of information associated with a plurality of cooking processes for cooking a food item and robot information indicating one cooking process of the plurality of cooking processes to be performed by a robot,

2. The information processing apparatus of claim 1, wherein the circuitry is further configured to:
initiate display of cooking person information indicating another cooking process of the plurality of cooking processes to be performed by a cooking person.

3. The information processing apparatus of claim 2, wherein the circuitry is further configured to:
select between the robot and the cooking person to perform the plurality of cooking processes, based on the information associated with the plurality of cooking processes.

4. The information processing apparatus of claim 3, wherein the circuitry is further configured to:
select between the robot information and the cooking person information as information to be displayed in association with the plurality of cooking processes, based on a result of the selection between the robot and the cooking person to perform the plurality of cooking processes.

5. The information processing apparatus of claim 3, wherein the circuitry is further configured to:
select between the robot and the cooking person to perform the plurality of cooking processes, based further on robot data of the robot and cooking person data of the cooking person.

6. The information processing apparatus of claim 5, wherein the cooking person data includes a feature or face of the cooking person to identify the cooking person.

7. The information processing apparatus of claim 5, wherein the cooking person data includes information indicating an age of the cooking person.

8. The information processing apparatus of claim 5, wherein the robot data includes information identifying the robot.

9. The information processing apparatus of claim 5, wherein the robot data includes costs of the robot at performing the plurality of cooking processes and the cooking person data includes costs of the cooking person at performing the plurality of cooking processes.

10. The information processing apparatus of claim 9, wherein the circuitry is further configured to:
compare the costs of the robot at performing the plurality of cooking processes and the costs of the cooking person at performing the plurality of cooking processes; and
select between the robot and the cooking person to perform the plurality of cooking processes, based further on a result of the comparison.

11. The information processing apparatus of claim 9, wherein the circuitry is further configured to:
determine the costs of the robot at performing the plurality of cooking processes, based on proficiency levels of the robot at performing the tasks of the plurality of cooking processes; and
determine the costs of the cooking person at performing the plurality of cooking processes, based on proficiency levels of the cooking person at performing the tasks of the plurality of cooking processes.

12. The information processing apparatus of claim 1, wherein the information associated with the plurality of cooking processes include task information indicating tasks of the plurality of cooking processes and material information indicating a quantity of materials used in the tasks.

13. The information processing apparatus of claim 12, wherein the circuitry is further configured to:
determine a cost of the robot at performing one task of the one cooking process to be a first cost when a proficiency level of the robot at performing the one task is a first level; and
determine a cost of the cooking person at performing the one task of the one cooking process to be a second cost higher than the first cost when a proficiency level of the cooking person at performing the one task is a second level lower than the first level.

14. The information processing apparatus of claim 13, wherein the circuitry is further configured to:
compare the cost of the robot at performing the one task and the cost of the cooking person at performing the one task;
determine the cost of the cooking person at performing the one task to be lower than the cost of the robot at perfuming the one task, based on a result of the comparison; and
select the robot to perform the one cooking process, based on a result of the determination.

15. The information processing apparatus of claim 1, wherein the information associated with the plurality of cooking processes for cooking the food item are displayed in an order of execution of the information associated with the plurality of cooking processes.

16. The information processing apparatus of claim 1, wherein the circuitry is further configured to:
initiate display of cooking tool information in association with the plurality of cooking processes indicating a cooking tool used in the plurality of cooking processes and cooking appliance information in association with the plurality of cooking processes indicating a cooking appliance used in the plurality of cooking processes.

17. The information processing apparatus of claim 16, wherein the circuitry is further configured to:
initiate display of cooking tool data including an icon indicating the cooking tool and cooking tool usage information indicating a usage situation of the cooking tool, and cooking appliance data including an icon indicating the cooking appliance and cooking appliance usage information indicating a usage situation of the cooking appliance.

18. The information processing apparatus of claim 16, wherein the circuitry is further configured to:
change the cooking tool information and cooking tool usage information to indicate the usage situation of the cooking tool detected based on a detected usage situation of the cooking tool; and
change the cooking appliance information and cooking appliance usage information to indicate the usage situation of the cooking appliance detected based on a detected usage situation of the cooking appliance.

19. An information processing method comprising:
displaying information associated with a plurality of cooking processes for cooking a food item and robot information indicating one cooking process of the plurality of cooking processes to be performed by a robot. thereon a program, which when executed by a computer causes the computer to execute an information processing method, the method comprising:
displaying information associated with a plurality of cooking processes for cooking a food item and robot information indicating one cooking process of the plurality of cooking processes to be performed by a robot.
